(19) United States
(12) Patent Application Publication
(10) Pub. No.: US 2025/0337884 A1
(43) Pub. Date: Oct. 30, 2025

(54) VIDEO ENCODING METHOD, VIDEO DECODING METHOD, AND STORAGE MEDIUM

(71) Applicant: GUANGDONG OPPO MOBILE TELECOMMUNICATIONS CORP., LTD., Dongguan (CN)

(72) Inventors: Fan WANG, Dongguan (CN); Lai ZHANG, Dongguan (CN)

(21) Appl. No.: 19/258,768

(22) Filed: Jul. 2, 2025

Related U.S. Application Data
(63) Continuation of application No. PCT/CN2023/070567, filed on Jan. 4, 2023.

(51) Int. Cl. H04N 19/105; H04N 19/159; H04N 19/176; H04N 19/70

(52) U.S. Cl. CPC H04N 19/105; H04N 19/159; H04N 19/176; H04N 19/70

(57) ABSTRACT

A video decoding method includes: decoding an intra template matching prediction mode usage flag of a current block; in a case of determining that the current block uses the intra template matching prediction mode according to the intra template matching prediction mode usage flag, decoding syntax elements of the intra template matching prediction mode of the current block; and constructing a candidate list for intra template matching prediction, determining a reference block or a reference block combination used by the current block according to the syntax elements and the candidate list, and determining an intra prediction value of the current block according to the reference block or the reference block combination used by the current block.

### CROSS-REFERENCE TO RELATED APPLICATION

This application is a Continuation application of International Application No. PCT/CN2023/070567 filed on Jan. 4, 2023, which is incorporated herein by reference in its entirety.

### TECHNICAL FIELD

Embodiments of the present disclosure relate to, but are not limited to, video technologies, and in particular, to an intra template matching prediction method, a video encoding method, a video decoding method, a device and a system.

### RELATED ART

Digital video compression technology is mainly used to compress huge digital picture video data for ease of transmission and storage. Currently, common video coding standards, such as H.266/versatile video coding (VVC), all adopt a block-based hybrid coding framework. Each frame in the video is partitioned into square largest coding units (LCUs) of the same size (e.g., 128×128, or 64×64). Each largest coding unit may be partitioned into rectangular coding units (CUs) depending on rules. The coding unit may further be partitioned into prediction units (PU), transform units (TU), and the like. The hybrid coding framework includes a prediction module, a transform module, a quantization module, an entropy coding module, an in loop filter module and other modules. The prediction module includes intra prediction and inter prediction for reducing or removing inherent redundancy in the video. The inter prediction includes motion estimation and motion compensation. Due to a strong correlation between adjacent samples in a picture in a video, in a video coding technology, the intra prediction is used to eliminate spatial redundancy between adjacent samples. Due to a strong similarity between adjacent pictures in a video, in the video coding technology, the inter prediction is used to eliminate temporal redundancy between adjacent pictures, thereby improving coding efficiency. Compared with a prediction signal, residual information is transformed, quantized and entropy coded into a bitstream in a unit of block.

With the surge in Internet videos and people's increasing demand for video clarity, although existing digital video compression standards may save a lot of video data, there is still a need to pursue a better digital video compression technology to reduce a bandwidth and traffic pressure of digital video transmission.

### SUMMARY

An embodiment of the present disclosure provides a candidate list construction method for intra template matching prediction, including:
determining a first search range for performing intra template matching prediction (intraTMP) on a current block;
searching for reference block templates according to the first search range, calculating differences between searched reference block templates and a current block template; where the reference block templates correspond one-to-one to reference blocks; and
constructing a candidate list for intraTMP according to the differences, and determining N reference blocks in the candidate list and an order of the N reference blocks, N being greater than or equal to 2.

An embodiment of the present disclosure further provides a video decoding method, including:
decoding an intra template matching prediction (intraTMP) mode usage flag of a current block;
in a case of determining that the current block uses the intraTMP mode according to the intraTMP mode usage flag, continuing to decode an intraTMP index of the current block; the intraTMP index is used to indicate a position of a reference block used by the current block in a candidate list for intraTMP; and
constructing a candidate list, and determining the reference block used by the current block according to the intraTMP index and the candidate list, and performing intra prediction on the current block according to the reference block used by the current block.

An embodiment of the present disclosure further provides a video encoding method, including:
in a case of determining that a multi-candidate intraTMP mode is allowed to be used for a current block, constructing a candidate list for intraTMP according to the candidate list construction method for intraTMP as described in any of embodiments of the present disclosure, where the candidate list includes N reference blocks, where N is greater than or equal to 2;
calculating an encoding cost in a case of performing prediction on the current block according to N reference blocks in the candidate list, and using a minimum encoding cost as an encoding cost of the multi-candidate intraTMP mode to participate in rate-distortion optimization; and
in a case of determining that the current block uses an intraTMP mode to perform intra prediction, encoding syntax elements related to the intraTMP mode of the current block.

An embodiment of the present disclosure further provides a candidate list construction method for intra template matching prediction, including:
determining a first search range for performing intra template matching prediction (intraTMP) on a current block;
searching for reference block templates according to the first search range, calculating differences between searched reference block templates and a current block template and between reference block template combinations and the current block template; where the reference block templates correspond one-to-one to reference blocks, and the reference block template combinations correspond one-to-one to reference block combinations; and
constructing a candidate list for intraTMP according to the differences, and determining a plurality of candidates in the candidate list and an order of the plurality of candidates.

An embodiment of the present disclosure further provides a candidate list construction method for intra template matching prediction, including:
determining a first search range for performing intra template matching prediction (intraTMP) on a current block; where the first search range is located within a reconstructed region of a current picture;
determining a group of block vectors (BVs) according to a first search step and the first search range, where positions indicated by the group of BVs are within the first search range;
searching for corresponding reference block templates according to the group of BVs, and calculating differences between the searched reference block templates and a current block template; and
filling BVs corresponding to N reference block templates with smallest differences into a candidate list in an ascending order of corresponding differences, where N is a length of the candidate list, and N is greater than or equal to 2;
where the reference block templates correspond one-to-one to reference blocks; the differences between the reference block templates and the current block template are determined according to a sum of absolute difference (SAD), a sum of absolute transformed difference (SATD) or a mean-square error (MSE) between reconstructed values of the reference block templates and reconstructed values of the current block template; a BV of a reference block is used to indicate a position of the reference block relative to the current block, and a BV corresponding to a reference block template is a BV of a reference block corresponding to the reference block template.

An embodiment of the present disclosure further provides a video decoding method, including:
decoding an intra template matching prediction (intraTMP) mode usage flag of a current block;
in a case of determining that the current block uses the intraTMP mode according to the intraTMP mode usage flag, continuing to decode syntax elements of the intraTMP mode of the current block; and
constructing a candidate list for intraTMP, determining a reference block or a reference block combination used by the current block according to the syntax elements and the candidate list, and performing intra prediction on the current block according to the reference block or the reference block combination used by the current block.

An embodiment of the present disclosure further provides a video encoding method, including:
in a case of determining that a multi-candidate intra template matching prediction (intraTMP) mode is allowed to be used for a current block, constructing a candidate list for intraTMP according to the method as described in any of embodiments of the present disclosure;
calculating an encoding cost in a case of performing prediction on the current block according to a reference block or a reference block combination in the candidate list, and using a minimum encoding cost as an encoding cost of the multi-candidate intraTMP mode to participate in rate-distortion optimization; and
in a case of determining that the current block uses an intraTMP mode to perform intra prediction, encoding syntax elements related to the intraTMP mode of the current block.

An embodiment of the present disclosure further provides a bitstream, and the bitstream is generated based on the video encoding method as described in any of embodiments of the present disclosure.

An embodiment of the present disclosure further provides a candidate list construction device for intra template matching prediction, including a processor and a memory having stored a computer program thereon, where the processor is capable of implementing the candidate list construction method for intra template matching prediction as described in any of embodiments of the present disclosure when executing the computer program.

An embodiment of the present disclosure further provides a video decoding device, including a processor and a memory having stored a computer program thereon, where the processor is capable of implementing the video decoding method as described in any of embodiments of the present disclosure when executing the computer program.

An embodiment of the present disclosure further provides a video encoding device, including a processor and a memory having stored a computer program thereon, where the processor is capable of implementing the video encoding method as described in any of embodiments of the present disclosure when executing the computer program.

An embodiment of the present disclosure further provides a video coding system, which includes the video encoding device as described in any of embodiments of the present disclosure and the video decoding device as described in any of embodiments of the present disclosure.

An embodiment of the present disclosure further provides a non-transitory computer-readable storage medium, where the computer-readable storage medium has stored a computer program thereon, the computer program, when executed by a processor, is capable of implementing the method as described in any of embodiments of the present disclosure.

An embodiment of the present disclosure further provides a computer program product, including a computer program, where the computer program, when executed by a processor, is capable of implementing the method as described in any of embodiments of the present disclosure.

An embodiment of the present disclosure further provides a method for determining a search range for intraTMP, including:
in a case where an intraTMP mode is allowed to be used for a current block, relative to a base point representing a position of the current block, determining a first search distance in a width direction and a second search distance in a height direction of the first search range as follows:
calculating a product of a width of the current block and a first scale factor, and using a larger value between the product and a set minimum search distance in the width direction as the first search distance; calculating a product of a height of the current block and a second scale factor, and using a larger value between the product and a set minimum search distance in the height direction as the second search distance, where the first scale factor and the second scale factor are equal or different; or
determining a larger value between a width of the current block and a set minimum search distance in the width direction, and using a product of the larger value and a first scale factor as the first search distance; determining a larger value between a height of the current block and a set minimum search distance in the height direction, and using a product of the larger value and a second scale factor as the second search distance, where the first scale factor and the second scale factor are equal or different; or
multiplying a width of the current block by a corresponding first scale factor to obtain the first search distance, where there are a plurality of first scale factors, and the larger the first scale factor, the larger the corresponding width of the current block; multiplying a height of the current block by a corresponding second scale factor to obtain the second search distance, where there are a plurality of second scale factors, and the larger the second scale factor, the larger the corresponding height of the current block.

### BRIEF DESCRIPTION OF THE DRAWINGS

The accompanying drawings are used to provide an understanding of the embodiments of the present disclosure and constitute a part of the specification. The accompanying drawings, together with the embodiments of the present disclosure, are used to explain the technical solutions of the present disclosure and do not constitute a limitation to the technical solutions of the present disclosure.

FIG. 1A is a schematic diagram of an encoding and decoding system in accordance with an embodiment of the present disclosure.

FIG. 1B is a block diagram of an encoding side in accordance with an embodiment of the present disclosure.

FIG. 1C is a block diagram of a decoding side in accordance with an embodiment of the present disclosure.

FIG. 2A is a schematic diagram of predicting a current block using an intra prediction method.

FIG. 2B is a schematic diagram of predicting a current block using a multiple reference line intra prediction method.

FIG. 3 is a schematic diagram of a traditional intra prediction mode used in a non-wide angle mode in VVC.

FIG. 4 is a schematic diagram of a traditional intra prediction mode used in a wide angle mode in VVC.

FIG. 5 is a schematic diagram of a traditional intra prediction mode used in AVS3.

FIG. 6 is a schematic diagram of intra prediction based on an IBC mode.

FIG. 7 is a schematic diagram of inter prediction based on template matching technology.

FIG. 8 is a schematic diagram of intra prediction based on an intraTMP mode.

FIG. 9 is a flowchart of a candidate list construction method for intraTMP in accordance with an embodiment of the present disclosure.

FIG. 10 is a schematic diagram of setting a search distance in accordance with an embodiment of the present disclosure.

FIG. 11 is a flowchart of a video decoding method in accordance with an embodiment of the present disclosure.

FIG. 12 is a flowchart of a video encoding method in accordance with an embodiment of the present disclosure.

FIG. 13A is a schematic diagram of positions indicated by BVs during a first-level search in accordance with an embodiment of the present disclosure.

FIG. 13B is a schematic diagram of determining a local search range during a second-level search based on a BV retained in a first-level search in accordance with an embodiment of the present disclosure.

FIG. 14 is a module diagram of an intra prediction device in accordance with an embodiment of the present disclosure.

FIG. 15 is a flowchart of another candidate list construction method for intraTMP in accordance with an embodiment of the present disclosure.

FIG. 16 is a flowchart of another candidate list construction method for intraTMP in accordance with an embodiment of the present disclosure.

FIG. 17 is a flowchart of another video decoding method in accordance with an embodiment of the present disclosure.

FIG. 18 is a flowchart of another video encoding method in accordance with an embodiment of the present disclosure.

FIG. 19 is a schematic diagram of obtaining a second reference block template in accordance with an embodiment of the present disclosure.

### DETAILED DESCRIPTION

The present disclosure describes a plurality of embodiments, but the description is exemplary rather than restrictive, and it is obvious to those skilled in the art that there may be more embodiments and implementations within the scope of the embodiments described in the present disclosure.

In the description of the present disclosure, terms such as “exemplarily” or “for example” are used to indicate examples, instances or illustrations. Any embodiment described as “exemplarily” or “for example” in the present disclosure shall not be construed as being more preferred or advantageous over other embodiments. The phrase “and/or” herein is a description of an association relationship of associated objects, and means that there may be three relationships. For example, A and/or B may indicate three cases that: A exists alone, both A and B exist, and B exists alone. The phase “multiple” means two or more than two. In addition, in order to clearly describe technical solutions of the embodiments of the present disclosure, terms such as “first” and “second” are used to distinguish identical items or similar items with substantially the same functions and effects. Those skilled in the art may understand that the terms such as “first” and “second” do not limit the quantity and execution order, and the terms such as “first” and “second” do not necessarily limit the differences.

As used herein, the description of “including any one or more of the following: option one, option two, . . . ” or “including any one or more of option one, option two, . . . ” means including any one of the listed options, or any combination of multiple of the listed options. For example, the description of “including any one or more of the following: A or B” or “including any one or more of A or B” means including only A, only B, or including both A and B. As another example, the description of “including any one or more of the following: A, B or C” or “including any one or more of A, B or C” means including only A, only B, only C, including both A and B, including both A and C, including both B and C, or including A, B and C. The same logic applies a case of more options.

In the description of representative exemplary embodiments, the method and/or process may be presented as a specific sequence of steps in the specification. However, to an extent that the method or process does not rely on the specific order of steps described herein, the method or process should not be limited to the specific order of steps described. As will be appreciated by ordinary skilled in the art, other orders of steps are possible. Therefore, the specific order of steps set forth in the specification should not be construed as limitations on the claims. Furthermore, claims directed to the method and/or process should not be limited to performing their steps in the order written, and those skilled in the art may readily understand that these orders may be changed and still remain within the spirit and scope of the embodiments of the present disclosure.

An intra prediction method, a video encoding method and a video decoding method in the embodiments of the present disclose may be applied to various video coding standards, such as H.264/advanced video coding (AVC), H.265/high efficiency video coding (HEVC), H.266/versatile video coding (VVC), audio video coding standard (AVS), and other standards formulated by moving picture experts group (MPEG), alliance for open media (AOM), joint video experts team (JVET) and extensions of these standards, or any other customized standards.

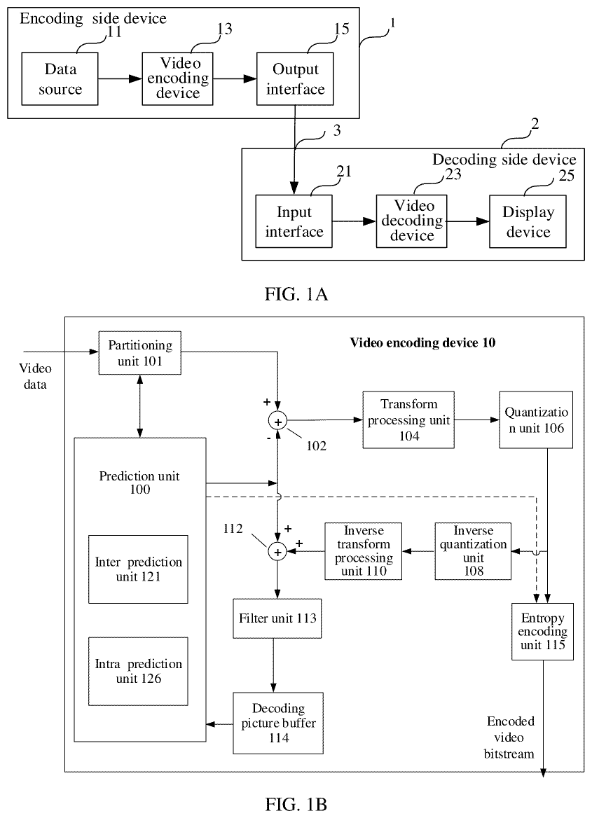

FIG. 1A is a block diagram of a video encoding and decoding system that may be used in the embodiments of the present disclosure. As shown in FIG. 1A, the system is divided into an encoding side 1 and a decoding side 2. The encoding side 1 generates a bitstream. The decoding side 2 can decode the bitstream. The decoding side 2 may receive the bitstream from the encoding side 1 via a link 3. The link 3 includes one or more media or devices capable of transferring the bitstream from the encoding side 1 to the decoding side 2. In an example, the link 3 includes one or more communication media that enable encoding side 1 to transmit the bitstream directly to decoding side 2. The encoding side 1 modulates the bitstream according to the communication standard and transmits the modulated bitstream to the decoding side 2. The one or more communication media may include wireless and/or wired communication media and may form part of a packet network. In another example, the bitstream may be output from an output interface 15 to a storage device, and the decoding side 2 may read the stored data from the storage device by streaming or downloading.

As shown in FIG. 1A, the encoding side 1 includes a data source 11, a video encoding device 13 and an output interface 15. The data source 11 includes a video capture device (e.g. a camera), an archive containing previously captured data, a feed interface for receiving data from a content provider, a computer graphics system for generating data, or a combination of these sources. The video encoding device 13 may also be referred to as a video encoding side, and is used to encode the data from the data source 11 and then output the encoded data to the output interface 15. The output interface 15 may include at least one of a regulator, a modem, or a transmitter. The decoding side 2 includes an input interface 21, a video decoding device 23 and a display device 25. The input interface 21 includes at least one of a receiver or a modem. The input interface 21 may receive the bitstream via the link 3 or from a storage device. The video decoding device 23 is also called a video decoding side, and is used to decode the received bitstream. The display device 25 is used to display the decoded data. The display device 25 may be integrated with other devices in the decoding side 2 or provided separately. The display device 25 is optional for the decoding side. In other examples, the decoding side may include other devices or apparatuses that apply the decoded data.

FIG. 1B is a block diagram of an exemplary video encoding device that may be used in the embodiments of the present disclosure. As shown in FIG. 1B, the video encoding device 10 includes following components.

A partitioning unit 101 is configured to cooperate with a prediction unit 100 to partition a received video data into slices, coding tree units (CTUs) or other relatively large units. The received video data may be a video sequence including a video frame such as an I frame (intra frame), a P frame (predicted frame) or a B frame (bidirectional frame).

The prediction unit 100 is configured to partition a CTU into coding units (CUs) and perform intra prediction coding or inter prediction coding on a CU. When the intra prediction and the inter prediction are performed on the CU, the CU may be partitioned into one or more prediction units (PUs).

The prediction unit 100 includes an inter prediction unit 121 and an intra prediction unit 126.

The inter prediction unit 121 is configured to perform inter prediction on a PU to generate prediction data of the PU, where the prediction data includes a prediction block of the PU, motion information of the PU, and various syntax elements. The inter prediction unit 121 may include a motion estimation (ME) unit and a motion compensation (MC) unit. The motion estimation unit may be used to perform motion estimation to generate a motion vector, and the motion compensation unit may be used to obtain or generate a prediction block based on the motion vector.

The intra prediction unit 126 is configured to perform intra prediction on a PU to generate prediction data of the PU. The prediction data of the PU may include a prediction block of the PU and various syntax elements.

A residual generating unit 102 (indicated by a circle with a plus sign after the partitioning unit 101 in FIG. 1B) is configured to generate a residual block of a CU by subtracting the prediction block of the PU partitioned from the CU from an original block of the CU.

A transform processing unit 104 is configured to partition the CU into one or more transform units (TUs), and the partition of the prediction units and the transform units may be different. A residual block associated with a TU is a sub-block obtained by partitioning the residual block of the CU. A coefficient block associated with the TU is generated by applying one or more transforms to the residual block associated with the TU.

A quantization unit 106 is configured to perform quantization on coefficients in the coefficient block based on a quantization parameter. A quantization degree of the coefficient block may be changed by adjusting the quantization parameter (QP).

An inverse quantization unit 108 and an inverse processing unit 110 are respectively configured to apply inverse quantization and inverse transform to the coefficient block to obtain a reconstructed residual block associated with the TU.

A reconstructed unit 112 (indicated by a circle with a plus sign after the inverse transform processing unit 110 in FIG. 1B) is configured to generate a reconstructed picture by adding the reconstructed residual block to the prediction block generated by the prediction unit 100.

A filter unit 113 is configured to perform in-loop filtering on the reconstructed picture.

A decoding picture buffer 114 is configured to store the reconstructed picture after performing in-loop filtering. The intra prediction unit 126 may extract a reference picture of a block adjacent to the current block from the decoding picture buffer 114 to perform intra prediction. The inter prediction unit 121 may perform inter prediction on the PU of a picture of a current picture using a reference picture of a previous picture buffered by the decoding picture buffer 114.

An entropy encoding unit 115 is configured to perform an entropy encoding operation on the received data (e.g., syntax elements, quantized coefficient blocks, motion information) to generate a video bitstream.

In other examples, the video encoding device 10 may include more, fewer, or different functional components than those in the present example. For example, the transform processing unit 104 and the inverse transform processing unit 110 may be eliminated.

FIG. 1C is a block diagram of an exemplary video decoding device that may be used in the embodiments of the present disclosure. As shown in FIG. 1C, the video decoding device 15 includes following components.

An entropy decoding unit 150 is configured to perform entropy decoding on a received encoded video bitstream to extract syntax elements, quantized coefficient blocks, motion information of a PU, and the like. A prediction unit 152, an inverse quantization unit 154, an inverse transform processing unit 155, a reconstructed unit 158 and a filter unit 159 may all perform corresponding operations based on the syntax elements extracted from the bitstream.

The inverse quantization unit 154 is configured to perform inverse quantization on a coefficient block associated with a quantized TU.

The inverse transform processing unit 155 is configured to apply one or more inverse transforms to an inverse quantized coefficient block to generate a reconstructed residual block of the TU.

The prediction unit 152 includes an inter prediction unit 162 and an intra prediction unit 164. If a current block is encoded using intra prediction, the intra prediction unit 164 determines an intra prediction mode of the PU based on syntax elements decoded from the bitstream, and performs intra prediction in combination with reconstructed reference information adjacent to the current block obtained from a decoding picture buffer 160. If a current block is encoded using inter prediction, the inter prediction unit 162 determines a reference block of the current block based on motion information of the current block and corresponding syntax elements, and obtaining the reference block from the decoding picture buffer 160 to perform inter prediction.

The reconstructed unit 158 (indicated by a circle with a plus sign after the inverse transform processing unit 155 in FIG. 1C) is configured to obtain a reconstructed picture based on the reconstructed residual block associated with the TU and a prediction block of the current block generated from intra prediction or inter prediction performed by the prediction unit 152.

The filter unit 159 is configured to perform in-loop filtering on the reconstructed picture.

The decoding picture buffer 160 is configured to store the reconstructed picture after performing in-loop filtering as a reference picture for subsequent motion compensation, intra prediction, inter prediction, and the like; or output the filtered reconstructed picture as decoded video data for presentation on a display device.

In other embodiments, the video decoding device 15 may include more, fewer or different functional components. For example, the inverse transform processing unit 155 may be eliminated in some cases.

Based on the video encoding device and the video decoding device mentioned above, the following basic encoding and decoding process can be performed. At the encoding side, a picture is partitioned into blocks, or partitioned into a plurality of slices and then partitioned into blocks. Slices in a same picture may be processed in parallel. Intra prediction, inter prediction or other algorithms are performed on a current block to generate a prediction block of the current block, the prediction block is subtracted from an original block of the current block to obtain a residual block, transform and quantization are performed on the residual block to obtain a quantization coefficient matrix, and entropy encoding is performed on the quantization coefficient matrix to generate a bitstream. At the decoding side, intra prediction or inter prediction is performed on a current block to generate a prediction block of the current block. In addition, a quantization coefficient matrix obtained by decoding the bitstream is inversely quantized and inversely transformed to obtain a residual block. The prediction block and the residual block are added to obtain a reconstructed block. The reconstructed blocks constitute a reconstructed picture. Loop-filtering is performed on the reconstructed picture based on the picture or on the block to obtain a decoded picture. The encoding side also obtains a decoded picture via operations similar to those of the decoding side, and the decoded picture may also be called a reconstructed picture after in-loop filtering. The reconstructed picture after in-loop filtering may be used as a reference picture for inter prediction of subsequent pictures. The block partitioning information, the mode information such as prediction, transform, quantization, entropy encoding and in-loop filtering, and the parameter information that are determined at the encoding side may be encoded into the bitstream. The decoding side determines the block partitioning information, the mode information such as prediction, transform, quantization, entropy encoding and in-loop filtering, and the parameter information that are used by the encoding side by decoding the bitstream or analyzing the existing information, so as to ensure that the decoded picture obtained by the encoding side is the same as the decoded picture obtained by the decoding side.

The example of a block-based hybrid coding framework is given above, but the embodiments of the present disclosure are not limited thereto. With the development of technologies, one or more modules in the framework and one or more steps in the process may be replaced or optimized. The embodiments of the present disclosure relate to, but are not limited to, the intra prediction units at the above-mentioned encoding side and decoding side and the corresponding intra prediction methods.

Herein, a current block may be a coding unit (CU) or a prediction unit (PU) currently being encoded or decoded, or a block-level coding unit such as a sub-block into which a CU or a PU is partitioned.

### Intra Prediction

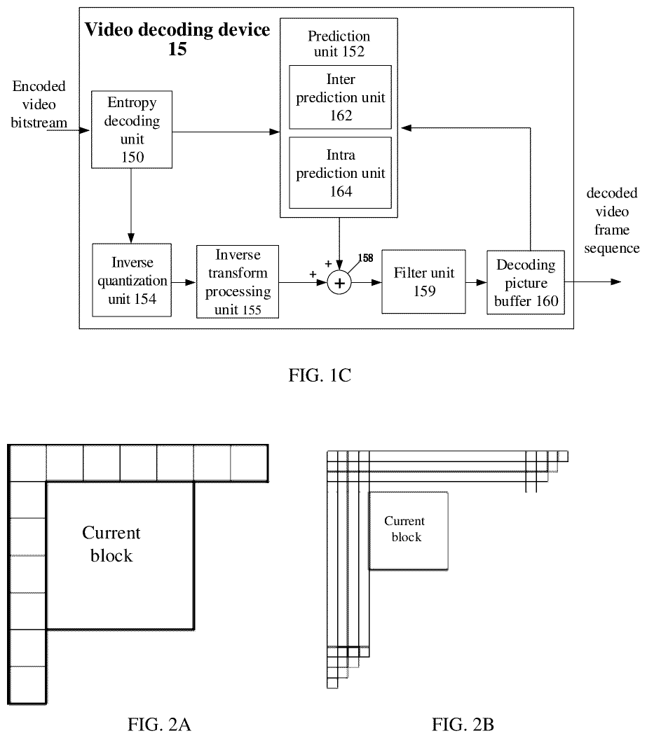

For the intra prediction mode, prediction is performed on the current block using reconstructed samples that have been encoded and decoded around the current block as reference samples. An example is shown in FIG. 2A, where a 4×4 block is the current block, and samples in a left column and a top row of the current block are reference samples of the current block. For the intra prediction, the prediction is performed on the current block by using these reference samples. All of these reference samples may have been encoded or decoded, or some of these reference samples may be unavailable. For example, if the current block is at the leftmost portion of the whole picture, then the reference samples at the left of the current block are unavailable. Alternatively, when the current block is encoded or decoded, samples at the bottom-left of the current block have not been encoded or decoded, so the reference samples at the bottom-left are also unavailable. For a case that the reference samples are unavailable, available reference samples or certain values or certain methods may be used for supplement or not.

For a multiple reference line (MRL) intra prediction mode, more reference samples may be used to improve the coding efficiency. FIG. 2B shows an example of using four reference rows/columns.

### Traditional Intra Prediction Mode

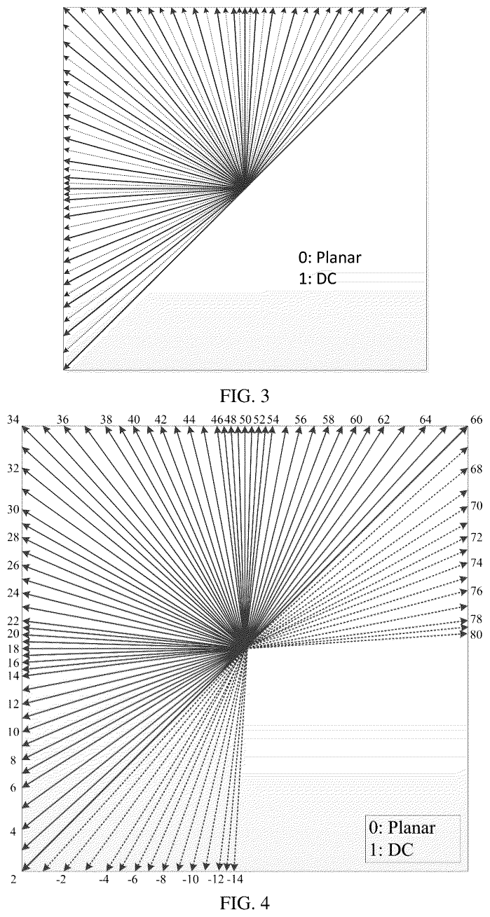

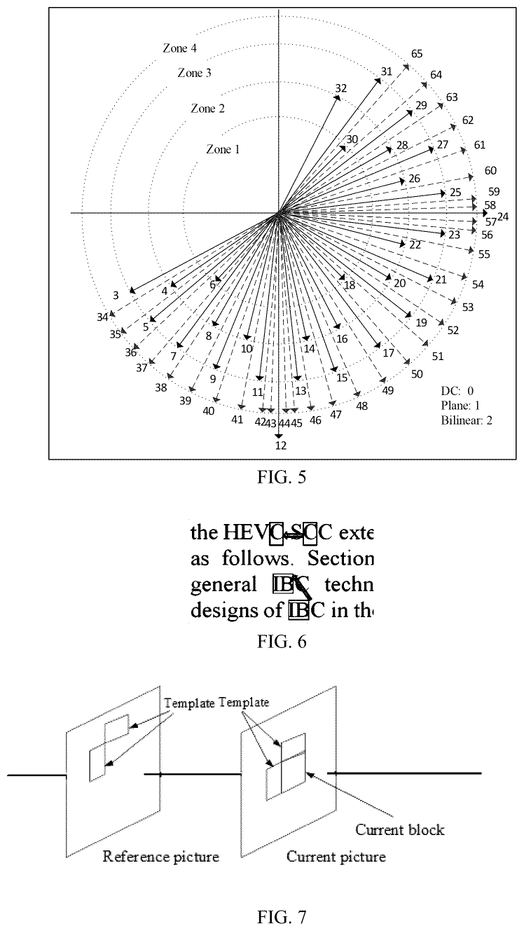

There are a plurality of prediction modes for intra prediction. With the development of technologies and an expansion of a block, there are more and more prediction modes. For example, the intra prediction modes used in HEVC include a planar mode, a direct current (DC) mode, and 33 angle modes, for a total of 35 prediction modes. The intra prediction modes used in VVC include a planar mode, a DC mode, and 65 angle modes, as shown in FIG. 3, for a total of 67 prediction modes. In addition to the above 67 modes, VVC further provides wide angle modes for some rectangular blocks with a large difference between a length and a width. For example, the modes indicated by dotted lines shown in FIG. 4, that is, two intervals of −14 to −1 and 67 to 80, will replace some conventional modes. AVS3 uses a DC mode, a planar mode, a bilinear mode, a pulse code modulation mode (PCM mode) and 62 angle modes, as shown in FIG. 5, for a total of 66 prediction modes.

### Inter Prediction

A video is composed of a plurality of pictures. In order to make the video look smooth, each second of video contains dozens or even hundreds of pictures, such as 24 pictures per second, 30 pictures per second, 50 pictures per second, 60 pictures per second, or 120 pictures per second. As a result, there is very obvious temporal redundancy in the video. In other words, there is a lot of temporal correlation. Inter prediction utilizes the temporal correlation to improve a compression efficiency. Inter prediction often uses “motion” to utilize temporal correlation. A very simple “motion” model is that an object is at a certain position on a picture corresponding to a certain moment, and after a certain period of time, the object moves to another position on a picture corresponding to this moment. This is known as translational motion in video coding. For inter prediction, motion information is used to represent “motion”. The basic motion information includes information of a reference frame (or referred to as a reference picture) and information of a motion vector (MV). The codec determines the reference picture according to the information of the reference picture, and determines coordinates of the reference block according to the information of the motion vector and coordinates of the current block. The reference block is determined by the coordinates thereof in the reference picture. Taking the determined reference block as the prediction block is the most basic prediction method of inter prediction.

The motion in the video is not always a simple motion. Even the motion that can be regarded as translation will have subtle changes over time, and the changes includes slight deformation, luma change, noise change, and the like. More than one reference block may be used to predict the current block to achieve a rather good prediction result. For example, in the commonly used bi-prediction nowadays, two reference blocks are used to predict the current block. The two reference blocks may be a forward reference block and a backward reference block. Further, it mays also be allowed that the two reference blocks are both forward reference blocks or both backward reference blocks. The video coding standards in the future may support prediction of multiple reference blocks. A simple method of generating a prediction block using two reference blocks is to average sample values at positions corresponding to the two reference blocks to obtain the prediction block. In order to obtain a rather good prediction result, weighted average may also be used, such as bi-prediction with CU-level weight (BCW) currently used in VVC. The geometric partitioning mode (GPM) in VVC may also be understood as a special bi-prediction. In order to use bi-prediction, it is naturally necessary to find two reference blocks, and thus two sets of information of the reference picture and two sets of information of the motion vector are required.

### Intra Block Copy (IBC)

The intra block copy (IBC) technology may significantly improve the compression efficiency of screen content coding. Therefore, from HEVC to VVC, IBC mode is used for the screen content coding. A screen content is different from a camera captured content, and is generated by a computer. The screen content has no noise, contains text and computer graphics, etc., and has a clear boundary. In addition, there is a lot of repeated contents in the screen content, as shown in FIG. 6.

For inter prediction, a reference block of a reference picture is used as a prediction block of a current block, and the reference picture is not the current picture. In the IBC mode, the inter prediction method is applied to the intra prediction. For the IBC mode, a block from an encoded and decoded portion (also called a reconstructed portion) of the current picture is searched for as a prediction block of the current block. The IBC mode is also called an intra picture block compensation mode or a current picture referencing (CPR) mode.

For the IBC mode, a block vector (BV) is used to represent a position difference between the current block and the reference block, which is similar to the motion vector (MV) used in inter prediction. The encoding side determines the optimal matching block of the current block within a search range by a block matching method and encodes the BV. The IBC method may be considered as an intra prediction method, or may be considered as another type of prediction method independent of intra prediction and inter prediction.

### Template Matching (TM)

The template matching (TM) technology is first used in inter prediction, and takes some regions around the current block as templates using the correlation between adjacent samples. When the current block is encoded and decoded, the left side and the top side of the current block have been encoded and decoded according to the encoding order. When actually implemented at the decoding side of hardware, it is not necessarily guaranteed that the left side and the top side of the current block have been decoded when the current block starts to be decoded. For example, when an inter encoded block in HEVC generates a prediction block, the surrounding reconstructed samples are not required, so the prediction process of the inter block may be carried out in parallel. However, for an intra encoded block, the reconstructed samples at the left and the top are required to be as reference samples. The corresponding adjustments in hardware design may enable the reconstructed samples on the left and top sides of the current block to be available. However, the reconstructed samples on the right side and the bottom side of the current block are not available according to the encoding order of existing standards such as VVC.

As shown in FIG. 7, the rectangular regions on the left and top sides of the current block are set as templates. The height of the template at the left is generally the same as the height of the current block, and the width of the template at the top is generally the same as the width of the current block, but the heights or the widths may also be different. The optimal matching position of the template is searched in the reference picture to determine the motion information, or referred to as the motion vector, of the current block. This process may be roughly described as follows: within a reference picture, starting from a starting position, a search is conducted within a certain surrounding region. The search rules, such as a search range and a search step, may be pre-set. Each time it moves to a position, a matching degree between the template corresponding to the position and a surrounding template of the current block is calculated. The matching degree may be measured by a difference, such as a sum of absolute difference (SAD), a sum of absolute transformed difference (SATD), or a mean-square error (MSE). The smaller the value of the SAD, the SATD, the MSE or the like, the higher the matching degree. The cost is calculated according to the prediction block of the template corresponding to the position and the reconstructed block of the surrounding template of the current block. The motion information of the current block is determined according to the position with the highest template matching degree searched. By using the correlation between adjacent samples, the motion information that is appropriate for the template may also be the motion information that is appropriate for the current block.

The template matching method may not necessarily be applicable to all blocks. Therefore, some methods may be used to determine whether to use the template matching method for the current block. For example, a control switch may be used in the current block to indicate whether to use the template matching method. A classic template matching technique is called decoder side motion vector derivation (DMVD). Both the encoding side and the decoding side may use the template to search and derive motion information, or find better motion information compared with the original motion information, which does not need to transmit specific motion vectors or motion vector differences. Instead, both the encoding and decoding sides search depending on the same rules to ensure consistency between encoding and decoding. The template matching method may improve compression performance, but it also requires “searching” on the decoding side, which brings a certain degree of complexity to the decoding side.

Intra Template Matching Prediction (intraTMP)

The intra template matching prediction (intraTMP) is a technology that combines IBC and TM. Applying TM to inter prediction may reduce the overhead of encoding MV. Similarly, applying TM to IBC may also reduce the overhead of encoding BV. An example is that there is no need to encode BV, and the block with the highest matching degree found according to TM is directly used as a prediction block of the current block in the intraTMP mode, and the intra prediction mode used by the current block is determined by participating in rate-distortion optimization.

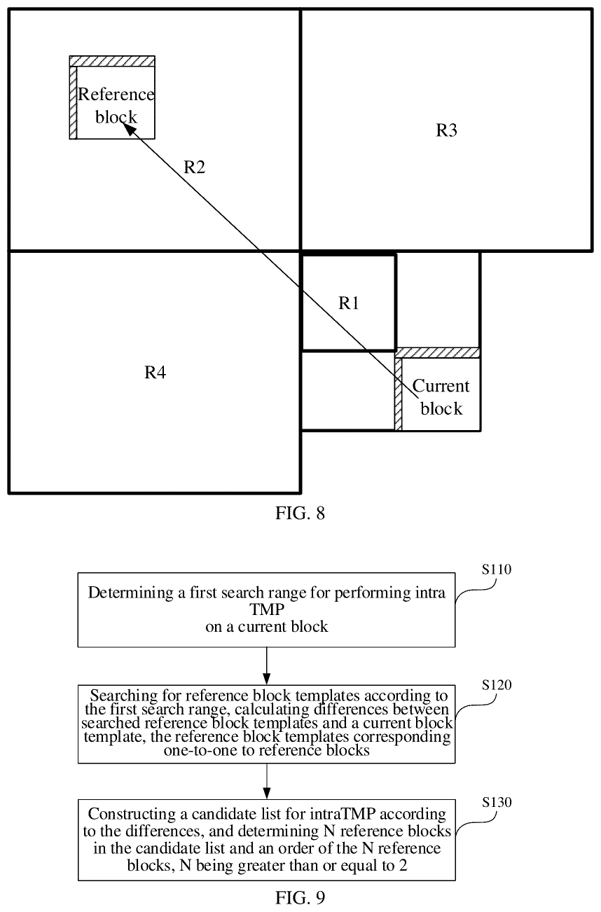

An example of intraTMP is shown in FIG. 8. An inverted L-shaped region on the top-left side of the current block is a template of the current block. As shown in FIG. 8, a partial region R1 of a current CTU, a CTU region R2 on the top-left side of the current block, a CTU region R3 on the top side of the current block, and a CTU region R4 on the left side of the current block are available reconstructed regions for searching. The reference block template should be searched within the available reconstructed regions, and the actual search range may be smaller than the reconstructed regions. However, this is only an example, and the available reconstructed regions may be different in actual application. In the example illustrated in FIG. 8, the optimal matching block which is the reference block corresponding to the reference block template that has the smallest difference (i.e., the highest matching degree) with the current block template, is found in the region R2 through search. The reference block in the region R2 in FIG. 8 is the optimal matching block, and the region filled with oblique lines surrounding the left and top sides of the reference block is the template of the reference block, which is also called the reference block template corresponding to the reference block.

As mentioned above, IBC may significantly improve the compression efficiency of screen content coding. One of the important reasons is that a lot of repeated blocks may be found in the screen content, and the screen content usually has a sharp boundary. In terms of color, there will be a large region with the same color (luma and chroma). However, this situation almost never occurs with content captured by a camera. The content captured by the camera has noise inevitably. Even if some regions of the content captured by the camera appear a uniform color at first glance, there may be more or less changes in luma and chroma. The content captured by the camera rarely has a sharp boundary. In addition, due to reasons such as perspective angle, it is difficult to find exactly the same blocks in the content captured by the camera, but repeated textures do exist in the content captured by the camera. Therefore, there are indeed approximately repeated blocks in the content captured by the camera, that is, there are only slight changes in noise and luma between blocks.

For the intraTMP, the optimal matching block found by intra template matching will be determined as the final prediction block. That is, when the current block is decoded, a flag is encoded to determine whether intraTMP is applied to the current block. If the current block uses intraTMP, a decoder will use the intra template matching method to search for an optimal matching block in the reconstructed region, and use a reconstructed value of the optimal matching block as the prediction value of the current block. The decoding side does not have an original value of the current block when searching, and may only use the block with the highest template matching degree as the optimal matching block searched by intraTMP. However, although the template is strongly related to the current block, it is not the current block after all. The optimal matching block found by template matching is not necessarily the optimal matching block of the actual current block. The coding efficiency in intraTMP mode needs to be further improved.

In light of this, the embodiments of the present disclosure provide a candidate list construction method for intra template matching prediction, and as shown in FIG. 9, the method includes the following steps:
S110, determining a first search range for performing intra template matching prediction (intraTMP) on a current block;
S120, searching for reference block templates according to the first search range, calculating differences between searched reference block templates and a current block template; where the reference block templates correspond one-to-one to reference blocks; and
S130, constructing a candidate list for intraTMP according to the differences, and determining N reference blocks in the candidate list and an order of the N reference blocks, N being greater than or equal to 2.

A reference block template corresponding to a reference block referred to herein is a template of the reference block. As shown in FIG. 8, a reference block and a template of the reference block are shown in the region R2. The template of the reference block is represented in FIG. 8 as a region filled with oblique lines, and is also referred to as the reference block template corresponding to the reference block. The size and shape of the reference block template are respectively the same as the size and shape of the current block template, and the relative positional relationship between the reference block template and the reference block is also the same as the relative positional relationship between the current block template and the current block. In the illustrated example, the current block template is an L-shaped region surrounding the left and top sides of the current block, and the template of the reference block is an L-shaped region surrounding the left and top sides of the reference block. The numbers of rows and columns included in the reference block template and the current block template are not limited in the embodiments of the present disclosure. In addition, a template of a block may also extend to a top-right side and/or a bottom-left side of the block.

In the embodiments of the present disclosure, a candidate list including a plurality of reference blocks is constructed via difference-based template matching, and the plurality of reference blocks in the candidate list may be used as the reference block of the current block for performing intra prediction in the intraTMP mode. The first option in the candidate list is the optimal matching block determined by template matching, but the coding efficiency of the optimal matching block when used for prediction of the current block is not necessarily the optimal. Using other reference blocks in the candidate list for prediction may result in a higher overall coding efficiency. By constructing the candidate list, an index may be used to indicate a reference block with the highest coding efficiency. The encoding side constructs the candidate list in the same way, and finds the reference block indicated by the index to predict the current block, thereby improving the coding efficiency.

In an exemplary embodiment of the present disclosure, the search range is located in a reconstructed region of a current picture, and the differences between the reference block templates and the current block template are determined according to an SAD, an SATD or an MSE between reconstructed values of the reference block templates and reconstructed values of the current block template. The SAD, the SATD or the MSE between the reconstructed values of the reference block templates and the reconstructed values of the current block template are used to represent the differences between the reference block templates and the current block template in the present embodiment, which can reflect the similarity between the two templates.

In an exemplary embodiment of the present disclosure, the order of the N reference blocks in the candidate list is determined in an ascending order according to the differences corresponding to the reference block templates. The template of the reference block has a strong correlation with the reference block. A reference block corresponding to the reference block template with the highest similarity determined by template matching (i.e., calculating the difference in templates) has a high probability of being the reference block with the largest similarity to the current block. Therefore, the order of the N reference blocks in the candidate list is determined according to the differences corresponding to the reference block templates in an ascending order in the embodiment of the present disclosure, so that the candidate reference block at the front has a high probability of being selected, and the codeword in this case is short, which may save coding overhead.

In an exemplary embodiment of the present disclosure, the reference block in the candidate list is identified by a block vector (BV) of the reference block, the BV of the reference block is used to indicate a position of the reference block relative to the current block, and a BV corresponding to the reference block template is the BV of the reference block corresponding to the reference block template.

In the present embodiment, the reference block is identified by the BV of the reference block in the candidate list, that is, what is actually filled in the candidate list is the BV. A position of the current block may be represented by a specified base point, and the base point may be a sample point in the current block. The base point in the present embodiment is a point (sample point) at the top-left corner of the current block, which is not limited thereto in the present disclosure. The base point in the present embodiment may also be a point at the top-right corner of the current block, a center point, or a point neighboring to the center point, etc. In other examples, a point on the current block template may be used as a base point. As long as the relative position of the base point and the current block remains unchanged and is known, the base point may be used to locate the current block. In the present embodiment, assuming that coordinates of the base point are (50,50) and coordinates of a point at the top-left corner of a reference block searched are (120,120), the BV used when searching for the reference block may be expressed as (70,70), that is, a position offset relative to the base point, which may be represented graphically, as illustrated in FIG. 8, by a vector pointing from the base point to the point at the top-left corner of the reference block. The resulting point by adding coordinates of the base point to the position offset indicated by the BV is called the position indicated by the BV. In FIG. 8, it is a point at the top-left corner of the reference block. For convenience of description herein, a BV of a reference block corresponding to a reference block template is called the BV corresponding to the reference block template, and the two are also in one-to-one correspondence.

In an exemplary embodiment of the present disclosure, searching for the reference block templates according to the first search range, calculating the differences between the searched reference block templates and the current block template, and constructing the candidate list for intraTMP according to the differences includes: determining a group of BVs according to a first search step and the first search range, where positions indicated by the group of BVs are within the first search range; searching for corresponding reference block templates according to the group of BVs, and calculating differences between the searched reference block templates and the current block template; and filling BVs corresponding to N reference block templates with the smallest differences into the candidate list.

In the present embodiment, the reference block templates are searched for based on the BVs. As mentioned above, a BV may indicate the position of the reference block. For example, in a case where a point on the top-left corner of the current block is used as the base point, the BV may indicate a point on the top-left corner of the reference block. Since a size and a shape of the reference block are the same as those of the current block, a region where the reference block is located, or the reconstructed samples included in the reference block, may be determined according to the position indicated by the BV. The relative position of the template of the reference block and the reference block remains unchanged, so a region where a reference block template is located may also be determined according to a BV. The reference block templates may be searched for based on a group of BVs. A reference block may be uniquely identified based on a BV, and thus the BV of the reference block may be used as a flag of the reference block and filled into the candidate list.

In the construction of the candidate list in the present embodiment, the N reference blocks in the candidate list and an order of the N reference blocks need to be determined according to the differences between the searched reference block templates and the current block template. In an example, N reference block templates initially searched are filled into a candidate list, and starting from the (N+1)th reference block template searched, a difference of a reference block template currently searched needs to be compared with the differences of the N reference block templates in the candidate list. If the difference of the reference block template is smaller than the largest difference among the differences of the N reference block templates in the candidate list, the candidate list is updated, the BV corresponding to the largest difference is deleted, and a BV corresponding to the reference block template is added to the candidate list. After processing the last searched reference block template, the construction of the candidate list is completed. During the construction, the N BVs in the candidate list are arranged in an ascending order according to the magnitudes of the corresponding differences, which may be convenient for comparison. The difference corresponding to the BV is the difference of the reference block template corresponding to BV. In another example, after obtaining all reference block templates as a result of search, N reference block templates with the smallest differences are added to the candidate list according to the differences of the reference block templates, so as to complete the construction of the candidate list.

Herein, the difference of the reference block template refers to the difference between the reference block template and the current block template, which is called the difference of the reference block template for convenience.

In an exemplary embodiment of the present disclosure, searching for the reference block templates according to the first search range, calculating the differences between the searched reference block templates and the current block template, and constructing the candidate list for intraTMP according to the differences includes:
determining a group of BVs according to the first search step and the first search range, searching according to the group of BVs, calculating the differences between the searched reference block templates and the current block template, and filling the BVs corresponding to the N reference block templates with the smallest differences into the candidate list; and
determining M second search ranges according to BVs corresponding to M reference block templates with the smallest differences searched in the first search, determining M groups of BVs according to a second search step and the M second search ranges, searching for corresponding reference block templates in the M second search ranges according to the M groups of BVs, calculating the differences between the searched reference block templates and the current block template, and updating the candidate list according to the differences; where the second search step is smaller than the first search step, the second search range is smaller than the first search range, and the second search ranges do not overlap with each other, M being greater than or equal to N.

In an example of the present embodiment, the BV is represented by a position offset relative to a base point, where the base point is a point (sample point or sub-sample point) in the current block. The M second search ranges respectively cover the positions indicated by the BVs corresponding to the M reference block templates, and the positions indicated by the BVs are determined according to the base point and the position offsets.

The present embodiment is a hierarchical search method, which is partitioned into two levels. A search step of the latter level is smaller than a search step of the former level. The latter level has a plurality of search ranges, and each search range is a portion of the search range of the former level. A larger search step is first used to perform a first-level search in the first search range, and N BVs are selected to fill in the candidate list according to the differences of the searched reference block templates; M second search ranges are determined in the second-level search according to M BVs recorded after the first-level search, search is performed in the second search ranges with a smaller step, and then the candidate list is updated according to the differences of the searched reference block templates. Hierarchical search is a search method from precise to detailed, which may find the reference block template with a high matching degree in the reconstructed region relatively quickly and accurately to complete the construction of the candidate list.

In an example of the present embodiment, after the candidate list is updated according to the differences, the method further includes:
determining M′ third search ranges according to BVs corresponding to M′ reference block templates with the smallest differences searched in the second search, determining M′ groups of BVs according to a third search step and the M′ third search ranges; searching for corresponding reference block templates in the M′ third search ranges according to the M′ groups of BVs, calculating the differences between the searched reference block templates and the current block template, and updating the candidate list according to the differences; where the third search step is smaller than the second search step, the third search range is smaller than the second search range, and the third search ranges do not overlap with each other, M′ being greater than or equal to N;
where a group of BVs determined for each third search range is BVs of integer samples; alternatively, a group of BVs determined for each third search range is BVs of sub-samples, and reconstructed values of the reference block template corresponding to the BV of the sub-sample is obtained by interpolation.

The present embodiment is a three-level search method, which performs a more detailed third-level search based on the second search, and may find reference block templates at more positions. As a result, there is a greater possibility of finding a reference block template with a higher actual matching degree. The reference block corresponding to the reference block template is also more likely to be close to the current block. Therefore, the method of the present embodiment may improve the coding efficiency.

In an exemplary embodiment of the present disclosure, updating the candidate list according to the differences includes:
determining a smallest difference di among the differences of the reference block templates searched within a same local search range, and in a case where di is smaller than D_{N}, updating the candidate list, where a BV corresponding to D_{N} is deleted from the candidate list, and a BV corresponding to d₁ is added to the candidate list;
where D_{N} is the largest difference among the differences corresponding to the N BVs in the candidate list before updating, a difference corresponding to a BV refers to the difference of the reference block template corresponding to the BV, and the local search range is the second search range or the third search range.

As described above, a local search range is determined based on the BV corresponding to the reference block template previously searched, the BV used to determine the local search range is also the BV in the local search range, and the reference block template previously searched based on the BV also belongs to the reference block templates searched in the local search range. Herein, the reference block templates searched in the same local search range include not only the reference block templates searched according to the determined local search range, but also the reference block templates corresponding to the BV used to determine the local search range. Taking the second search range as an example, the reference block templates searched within the same second search range include the reference block templates searched in the second search range during the second-level search, and further include the reference block template corresponding to the BV used to determine the second search range (searched in the first-level search). For the third search range, the reference block templates searched within the same third search range include the reference block templates searched in the third search range during the third-level search, and further include the reference block template corresponding to the BV used to determine the third search range (searched in the first-level search or the second-level search).

The updating process of the candidate list in the present embodiment may be applied after the second-level search or after the third-level search. During updating in the present embodiment, at most one of the BVs corresponding to the reference block templates searched from the same group of BVs (i.e., the BVs of the reference block templates searched in a local search range) is limited to be added to the candidate list. The local search range may be the second search range, the third search range, or the like. If it is a second-level search, each group of BVs in the determined M groups of BVs is processed in this way. If it is a third-level search, each group of BVs in the determined M′ groups of BVs is processed in this way. In addition, in a case of adding a new BV to the candidate list in each embodiment, may reorder the N BVs in the updated candidate list according to the order of corresponding differences from small to large.

In the present embodiment, a maximum number of BVs corresponding to reference block templates searched within a local search range that are added to the candidate list is limited to one, and the reason lies in that it is easy to fill BVs of multiple reference block templates that are close in the candidate list due to similarity in differences of reference block templates that are close, which may causes the reference blocks in the candidate list to be too concentrated in a certain position. Further, if a reference block at the position does not have high similarity to the current block, there will be multiple reference blocks in the candidate list that do not have high similarity to the current block, which makes the adaptability of the candidate list weak. By limiting the above number, positions of the reference blocks added to the candidate list will not be too concentrated. The texture features of these reference blocks are different, so as to avoid a situation to a certain extent where no block with a high matching degree with the current block can be found in the candidate list due to excessively concentrated positions of the reference blocks.

In an exemplary embodiment of the present disclosure, updating the candidate list according to the differences includes:
determining smallest K differences among the differences of the reference block templates searched within a same local search range, and in a case where at least one of the K differences is smaller than D_{N}, updating the candidate list, where N BVs in the candidate list after updating are N BVs with the smallest differences among BVs corresponding to the K differences and N BVs in the candidate list before updating, K is a set threshold and K is greater than or equal to 2;
where D_{N} is the largest difference among the differences corresponding to the N BVs in the candidate list before updating, a difference corresponding to a BV refers to the difference of the reference block template corresponding to the BV, and the local search range is the second search range or the third search range.

The difference between the present embodiment and the previous embodiment is that the maximum number of BVs corresponding to reference block templates searched within a local search range that are added to the candidate list is limited to K, where K is an integer greater than or equal to 2. The set threshold may be agreed upon, that is, default to a certain value, or may be set at the encoding side and then transmitted from the encoding side to the decoding side.

In an exemplary embodiment of the present disclosure, updating the candidate list according to the differences includes:
for each reference block template searched, in a case where a difference of a reference block template is less than D_{N}, updating the candidate list, where a BV corresponding to D_{N} is deleted from the candidate list, and a BV corresponding to the reference block template is added to the candidate list;
where D_{N} is the largest difference among the differences corresponding to the N BVs in the candidate list before updating, a difference corresponding to the BV refers to the difference of the reference block template corresponding to the BV.

The number of BVs corresponding to reference block templates searched within a local search range that may be added to the candidate list is not limited in the present embodiment. A BV of each reference block template searched within the local search range may be added to the candidate list if the corresponding difference is small enough. In the present embodiment, a plurality of BVs added to the candidate list may be concentrated in a local region. Although there is a certain problem with adaptability, in a case where the reference block at this position has a high matching degree with the current block, a reference block that is closer to the highest matching degree may be searched. The updating of the candidate list in the present embodiment includes situations where the candidate list is determined not to be updated via difference comparison and the candidate list is determined to be updated via difference comparison.

In the present embodiment, after calculating the difference of each reference block template, difference comparison and updating may be performed immediately; alternatively, after calculating the differences of reference block templates searched within the local search range, difference comparison and updating are performed one by one; alternatively, after calculating the differences of reference block templates searched within all local search ranges, difference comparison and updating are performed one by one. Fewer cache resources are required in the first processing method.

In an exemplary embodiment of the present disclosure, a size of the first search range is determined according to the size of the current block.

In an example of the present embodiment, relative to a base point representing a position of a current block, of the first search range, a first search distance in a width direction and a second search distance in a height direction are determined as the following manner:
calculating a product of a width of the current block and a first scale factor, and using a larger value between the product and a set minimum search distance in the width direction as the first search distance; calculating a product of a height of the current block and a second scale factor, and using a larger value between the product and a set minimum search distance in the height direction as the second search distance, where the first scale factor and the second scale factor are equal or different; or
determining a larger value between a width of the current block and a set minimum search distance in the width direction, and using a product of the larger value and a first scale factor as the first search distance; determining a larger value between a height of the current block and a set minimum search distance in the height direction, and using a product of the larger value and a second scale factor as the second search distance, where the first scale factor and the second scale factor are equal or different; or
multiplying a width of the current block by a corresponding first scale factor to obtain the first search distance, where there are a plurality of first scale factors, and the larger the first scale factor, the larger the corresponding width of the current block; multiplying a height of the current block by a corresponding second scale factor to obtain the second search distance, where there are a plurality of second scale factors, and the larger the second scale factor, the larger the corresponding height of the current block.

In the present embodiment, the size of the search range is represented by search distances in both the width direction and the height direction. As shown in FIG. 10, searchRangeWidth represents the first search distance of the first search range in the width direction relative to the base point (a point at the top-left corner of the current block), and searchRangeHeight represents the second search distance of the first search range in the height direction relative to the base point. The size of the search range in the present embodiment may also be expressed in different ways. For example, in FIG. 10, twice the value of searchRangeWidth is defined as the search distance in the width direction, and twice the value of searchRangeHeight is defined as the search distance in the height direction.

In the present embodiment, different search ranges are adopted according to different current blocks. Since the reference block has the same size as the current block, such a manner enables the number of reference blocks searched not to vary greatly with the size of the current block, thereby ensuring enough reference blocks available for matching, and further ensuring the coding effect of the intraTMP mode.

In an exemplary embodiment of the present disclosure, determining the first search range for performing intraTMP on the current block includes: determining a region covered by the first search range according to a base point representing the position of the current block, a search distance relative to the base point, and available reconstructed regions during searching. In the present embodiment, as shown in FIGS. 8 and 10, in a case of determining the actual region covered by the first search range, it is necessary to consider the base point, the search distances relative to the base point (including distances in two directions), and the available reconstructed regions during searching. The available reconstructed region is related to the set search direction. For example, as shown in FIG. 10, the search (i.e., the reference block template at the corresponding position is searched for according to a BV) may only be performed on the left side, top side, top-left side, bottom-left side and top-right side of the current block, and reconstructed regions in these directions are available. In other examples, the search direction may be limited to the left side, the top side, and the top-left, which is not limited in the present disclosure. The available reconstructed region during searching may also be directly set. For example, as shown in FIG. 8, the reconstruction regions within the CTU where the current block is located and within the CTUs at the top, left, and top-left sides of the current block are permitted for use during searching. In addition, there may be some other restrictions. For example, it is stipulated that regions located on the top side and left side of the current block in the CTU where the current block is located are not available, and so on.

After determining a group of BVs according to the search range and the search step, if the reference block sample searched according to the BV is not in the available reconstructed regions, the reference block template may be discarded; alternatively, after determining the BV, it is determined whether the reference block template searched according to the BV is in the available reconstructed regions, and if not, the BV is discarded. As a result, the searched reference block template is within the available reconstructed region.

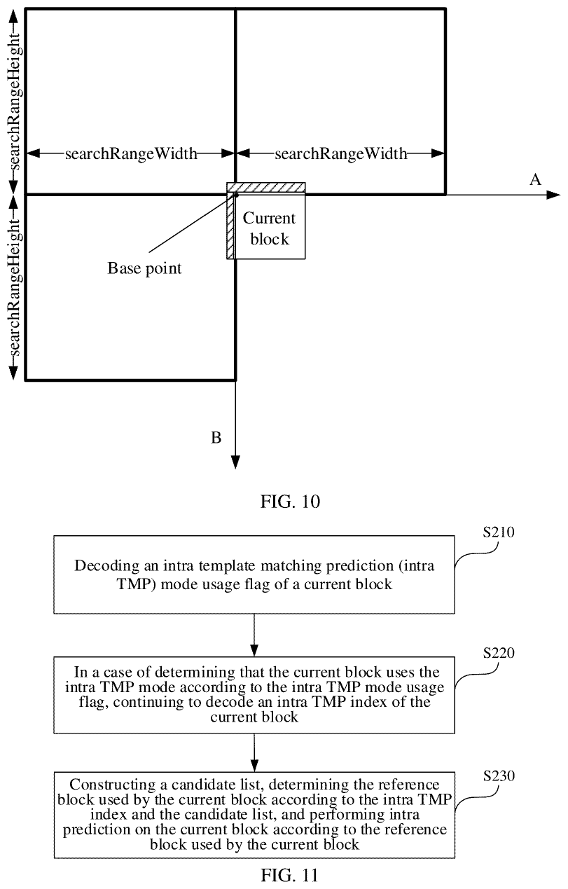

The embodiments of the present disclosure further provides a video decoding method, and as shown in FIG. 11, the method includes:
S210, decoding an intra template matching prediction (intraTMP) mode usage flag of a current block;
S220, in a case of determining that the current block uses the intraTMP mode according to the intraTMP mode usage flag, continuing to decode an intraTMP index of the current block; where the intraTMP index is used to indicate a position of a reference block used by the current block in a candidate list for intraTMP; and
S230, constructing a candidate list, and determining the reference block used by the current block according to the intraTMP index and the candidate list, and performing intra prediction on the current block according to the reference block used by the current block.

The intraTMP mode in the present embodiment is a multi-candidate intraTMP mode. During decoding, a candidate list may be constructed, a reference block used by the current block may be determined according to the intraTMP index and the candidate list, and intra prediction may be performed on the current block according to the reference block used by the current block. Since the candidate list includes a plurality of reference blocks, it is possible to find a reference block with a higher matching degree for the current block during prediction, thereby improving the coding efficiency.

In an exemplary embodiment of the present disclosure, the candidate list is constructed according to the candidate list construction method for intra TMP in any of the embodiments of the present disclosure. It should be noted that in a case of constructing the candidate list according to the candidate list construction method for intraTMP in any of the embodiments of the present disclosure, it is not necessary to construct a candidate list with a length of N, and a candidate list with a length less than N may be constructed to simplify processing. For example, the reference block used by the current block is determined at the third position in the candidate list according to the intraTMP index, in a case where N is equal to 5, the decoding side may construct a candidate list with a length of 3. The construction method may be the same, but the length is different.

In an exemplary embodiment of the present disclosure, after decoding the intraTMP index of the current block, the method further includes:
in a case where the intraTMP index indicates the first position in the candidate list, no longer constructing the candidate list, and performing intra prediction on the current block based on a single-candidate intraTMP mode; and
in a case where the intraTMP index indicates a position other than the first position in the candidate list, constructing a candidate list, and determining a reference block used by the current block according to the intraTMP index and the candidate list.

In the present embodiment, in a case where the intraTMP index indicates the first position in the candidate list, the reference block used by the current block may be found by using the single-candidate intraTMP mode. Therefore, there is no need to construct a candidate list, which may reduce the complexity of decoding.

In an exemplary embodiment of the present disclosure, the method further includes: decoding an intraTMP multi-candidate flag, and determining whether a multi-candidate intraTMP mode is allowed to be used according to the intraTMP multi-candidate flag, where the intraTMP multi-candidate flag is a sequence level flag, a picture level flag or a slice level flag; and
after determining that the current block uses the intraTMP mode according to the intraTMP mode usage flag, the method further includes:
in a case of determining that the multi-candidate intraTMP mode is allowed to be used according to the intraTMP multi-candidate flag, continuing to decode an intraTMP index of the current block; and
in a case of determining that the multi-candidate intraTMP mode is not allowed to be used according to the intraTMP multi-candidate flag, skipping decoding the intraTMP index of the current block, and performing intra prediction on the current block based on a single-candidate intraTMP mode.

In the present embodiment, a high-level intraTMP multi-candidate flag is used to indicate whether the multi-candidate intraTMP mode is allowed. In this way, in a case where the intraTMP multi-candidate flag indicates that the multi-candidate intraTMP mode is not allowed, and in a case where it is determined that the current block uses the intraTMP mode according to the intraTMP mode usage flag, there is no need to decode the intraTMP index, and intra prediction may be directly performed on the current block based on the single-candidate intraTMP mode, which may simplify the processing flow of the decoder.

In an exemplary embodiment of the present disclosure, decoding the intraTMP index of the current block includes:
implementing inverse binarization of the intraTMP index by a parsing method corresponding to variable-length coding, fixed-length coding, truncated unary coding, or truncated binary coding; or
parsing a value of a first binary symbol in the intraTMP index, in a case where the value indicates that the intraTMP index uses variable-length coding or truncated unary coding to encode, implement inverse binarization of the intraTMP index by a parsing method corresponding to variable-length coding or truncated unary coding, and in a case where the value indicates that the intraTMP index uses fixed-length coding or truncated binary coding, implement inverse binarization of the intraTMP index by a parsing method corresponding to fixed-length coding or truncated binary coding.

In the present embodiment, the parsing method of implementing inverse binarization of the intraTMP index is determined by a value of a first binary symbol in the intraTMP index. In a case where the intraTMP index may be encoded in a variety of ways, decoding of the intraTMP index may be implemented simply and conveniently.

In an exemplary embodiment of the present disclosure, before constructing the candidate list, the method further includes: decoding a search step index of an intraTMP mode, where the search step index is used to indicate an index of a used search step in a plurality of candidate search steps; and
during constructing the candidate list, searching for the reference block template in the first search range according to a search step determined by the search step index.

In the present embodiment, search in the intraTMP mode may be performed for the current block using different steps, which has good adaptability to different pictures.

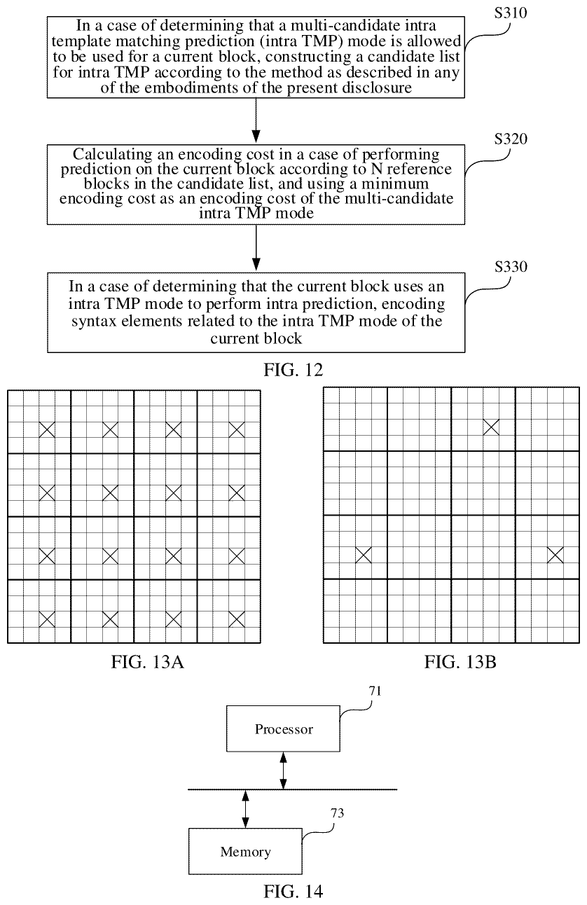

The present disclosure further provides a video encoding method, and as shown in FIG. 12, the method includes:
S310, in a case of determining that a multi-candidate intraTMP mode is allowed to be used for a current block, constructing a candidate list for intraTMP according to the method as described in any of the embodiments of the present disclosure;
S320, calculating an encoding cost in a case of performing prediction on the current block according to N reference blocks in the candidate list, and using a minimum encoding cost as an encoding cost of the multi-candidate intraTMP mode to participate in rate-distortion optimization; and
S330, in a case of determining that the current block uses an intraTMP mode to perform intra prediction, encoding syntax elements related to the intraTMP mode of the current block.

In the present embodiment, the minimum encoding cost is a rate-distortion cost.

The encoding cost in a case of performing prediction on the current block according to the reference block in the above candidate list may be calculated by a difference between a reconstructed value of the reference block and an original value of the current block, or the encoding cost may be determined according to the rate-distortion cost (including a code rate part and a distortion part) in a case of performing prediction on the current block using the reference block, or the encoding cost may be determined by a combination of these two methods, that is, the reference blocks in the candidate list are sorted through the encoding costs determined using the first method, and then the encoding costs are calculated using the second method for some reference blocks with high sorting, and then the reference blocks are reordered.

After determining the encoding cost of the multi-candidate intraTMP mode, the encoding cost of the multi-candidate intraTMP mode may be compared with the encoding cost (such as rate-distortion cost) in a case where other intra prediction modes are used for the current block. If the encoding cost of the multi-candidate intraTMP mode is the smallest, it may be determined that the current block uses the multi-candidate intraTMP mode.

The intraTMP mode in the present embodiment is a multi-candidate intraTMP mode. A candidate list is constructed during encoding, and in a case where the intra TMP mode is selected for rate-distortion optimization, syntax elements related to the intra TMP mode of the current block are encoded to indicate the reference blocks used by the current block in the multi-candidate intraTMP mode. Since the candidate list includes a plurality of reference blocks, it is possible to search a reference block with a higher matching degree for the current block during prediction, which may improve the coding efficiency.

In an exemplary embodiment of the present disclosure, encoding the syntax elements related to the intraTMP mode of the current block includes:
encoding an intraTMP mode usage flag of the current block to indicate that the current block uses the intraTMP mode; and
encoding an intraTMP index of the current block to indicate a position of the reference block or reference block combination used by the current block in the candidate list.

In the present embodiment, the intra TMP mode usage flag and the intra TMP index are encoded, so that the decoding side may determine the reference block used by the current block according to the two syntax elements, and then perform intra prediction on the current block based on the reference block used by the current block.

In an exemplary embodiment of the present disclosure, encoding the intraTMP index of the current block includes:
implementing binarization of the intraTMP index by variable-length coding, fixed-length coding, truncated unary coding, or truncated binary coding; or
in a case where a value of the intraTMP index is located within a first value range, implementing binarization of the intraTMP index by the variable-length coding or the truncated unary coding; and in a case where a value of the intraTMP index is located within a second value range, implementing binarization of the intraTMP index by the fixed-length coding or the truncated binary coding, where values in the first value range are smaller than values in the second value range.

In the present embodiment, during encoding, the variable-length coding or the truncated unary coding may be used for encoding in a case where the value of the intraTMP index is small, and the word is short, and the fixed-length coding or the truncated binary coding may be used for encoding in a case where the value of the intraTMP index is large. In this way, the coding overhead may be saved.

In an exemplary embodiment of the present disclosure, determining that the multi-candidate intraTMP mode is allowed to be used for the current block includes: in a case where all conditions in which the multi-candidate intraTMP mode is not allowed to be used are not met, determining that the multi-candidate intraTMP mode is allowed to be used for the current block, where the conditions in which the multi-candidate intraTMP mode is not allowed to be used include: an intraTMP multi-candidate flag at a sequence level, a picture level or a slice level indicating that the multi-candidate intraTMP mode is not allowed to be used.

In an example of the present embodiment, when encoding the screen content, the intraTMP multi-candidate flag is set to a value indicating that the multi-candidate intra TMP mode is not allowed to be used; and when encoding a video picture captured by the camera, the intraTMP multi-candidate flag is set to a value indicating that the multi-candidate intraTMP mode is allowed to be used.

The present embodiment may be used for different usage scenarios. In a case where it is suitable to use the multi-candidate intraTMP mode, the intraTMP multi-candidate flag may be encoded to indicate that the multi-candidate intraTMP mode is allowed to be used, so as to improve the encoding effect; and in a case where it is not suitable to use the multi-candidate intraTMP mode, the intraTMP multi-candidate flag may be encoded to indicate that the multi-candidate intraTMP mode is not allowed to be used, so as to avoid unnecessary encoding complexity.

In an exemplary embodiment of the present disclosure, the method further includes: in a case of performing intra prediction encoding on the current block based on a single-candidate intraTMP mode, encoding an intraTMP mode usage flag of the current block to indicate that the current block uses the intraTMP mode; and encoding an intraTMP index of the current block to indicate that the reference block used by the current block is at a first position in the candidate list. In the present embodiment, it is not necessary to use an additional flag to indicate whether the single-candidate intraTMP mode or the multiple-candidate intraTMP mode is used for the current block, and the determination is completed via the intraTMP index, which may simplify the complexity of the decoding side.

An embodiment of the present disclosure further provides a multi-candidate intra template matching prediction (intraTMP) method. In the present embodiment, N candidates are set for intraTMP, where N is greater than or equal to 2, that is, a candidate list for intraTMP with a length of N is set, which is denoted as intra TMPCandList [N].

At an encoding side, a plurality of reference block templates are found within a set search range depending on set search rules, differences between the plurality of reference block templates and a current block template are calculated according to reconstructed sample values of the plurality of reference block templates and a reconstructed sample value of the current block template, and position flags of reference blocks corresponding to N reference block templates are filled into a candidate list for intraTMP in an order of the differences from small to large.

At the encoding side, differences between N reference blocks and a current block are calculated according to reconstructed sample values of the N reference blocks in the candidate list and an original sample value of the current block, and a value of an intraTMP index is determined according to a position of a reference block with the smallest difference in the candidate list. The reference block with the smallest difference is the reference block used by the current block in the intraTMP mode, that is, the optimal matching block searched. If a BV is filled into the candidate list as a position flag of the reference block, a BV at a position indicated by the intraTMP index in the candidate list may also be called the BV used by the current block in the intraTMP mode.

If the encoding side has undergone rate-distortion optimization and selected the intraTMP mode for the current block in a plurality of intra prediction modes (i.e., it is determined that the current block uses the intraTMP), after encoding a flag indicating that the current block uses the intraTMP mode, an intraTMP index is continued to be encoded to indicate a position of the reference block used by the current block in the candidate list.

Correspondingly, the syntax for decoding is as follows,

intraTMPFlag
if (intraTMPFlag)
{
intraTMPIndex
}

where intraTMPFlag is a flag indicating whether the current block uses the intraTMP mode, and intraTMPIndex is an intraTMP index used to indicate the position of the reference block used by the current block in the candidate list.

During decoding, if intraTMPFlag is true (e.g., 1), intraTMPIndex is continued to parse. The decoding side constructs the candidate list intraTMPCandList for intraTMP in the same way, finds a position flag at the position indicated by intraTMPIndex in intraTMPCandList, finds a corresponding reference block based on the position flag, and may use a reconstructed value of the reference block as a prediction value of the current block.

During constructing intraTMPCandList in the present embodiment, for each BV searched within the search range, a difference between the reference block template corresponding to the BV and the current block template is calculated. The reference block template is a block, with the same shape and the same size as the current block, searched in a reconstructed region. The difference may be an SAD, an SATD, an MSE, or the like. During constructing intraTMPCandList, BVs corresponding to the searched reference block templates may be filled into intraTMPCandList in an ascending order of the differences. In other words, the searched reference block templates are sorted in an ascending order of the corresponding differences, and reference blocks corresponding to the first N reference block templates are used as the N reference blocks in intraTMPCandList. Alternatively, only the first N candidates with the smallest differences may be maintained, and reference block templates with a ranking exceeding N may be directly discarded, thereby saving computational load.

Usually, blocks corresponding to adjacent BVs are relatively close, especially in a case where the BV supports sub-sample precision, such as ½, ¼, ⅛, or 1/16 precision. A reference block template corresponding to a BV of a sub-sample needs to be obtained by interpolation. In a case where interpolation is performed on the intra templates (intraTMP), the same filter as the inter interpolation filter may be used, so that storage of additional filters may be reduced by multiplexing. Simpler interpolation methods may also be used. The inter interpolation uses a 12-tap filter, and a filter with fewer taps, such as an 8-tap filter, 4-tap filter or even a 2-tap filter, may be used in the present embodiment, so as to reduce the computational load.

In a case where the BV supports sub-sample precision, if it is not controlled and only sorted according to the differences of the reference block templates, it is easy to concentrate multiple candidates into a very small range. The present embodiment provides the following method to perform some control to avoid excessive concentration of candidate BVs in intraTMPCandList.

The first method is as follows.

During searching, not every possible BV is searched sequentially. For example, a usual search order is from left to right and from top to bottom. Generally, BVs of integer samples may be searched sequentially. As shown in FIGS. 13A and 13B, assuming that the BV currently searched is (x0, y0), the next one is (x0+1, y0), and the premise is that a boundary of the search range has not been reached. The first approach is to do a sparse search. For example, for the BVs of the integer samples, if the currently searched BVis (x0, y0), the next one is (x0+4, y0), and the premise is that the boundary of the search range has not been reached. Template matching (i.e., searching for a reference block template and calculating the difference between the searched reference block template and the current block template) is performed every certain number of samples, and the template matching is performed according to the set search size. The search size may be a preset value, such as 2, 3, 4 or 8. The same process may be done in a vertical direction.

N BVs with the smallest corresponding differences are searched, and then based on the N BVs with the smallest corresponding differences (the differences may also be called costs or distortion costs), searching are performed again within a small local search range based on each BV for improvement. For example, if search intervals of the first-level search in x and y directions are 4 samples, the local search range here may be set to 4×4. In a case where the difference of the reference block template searched in the local search range is small, the corresponding BV may replace a BV in the candidate list and N candidates in the candidate list are resorted. In this way, the BVs corresponding to the N reference blocks in the candidate list have certain distances.

As shown in FIG. 13A, the first-level search is performed according to a preset step, and points at the top-left corners of the reference blocks searched are shown as the points marked with crosses in FIG. 13A. After searching, three sorted BVs are found, and points at the top-left corners of the reference blocks (that is, the positions indicated by the BVs) corresponding to the three BVs are shown as the points marked with crosses in FIG. 13B. In this example, the search step in a horizontal direction is 4, and the search step in the vertical direction is also 4. When the second-level search is performed, a local search range is determined based on the three sorted BVs, such as a 4×4 rectangular region in this example covering the positions indicated by the three sorted BVs in FIG. 13B (the small cells with crosses in the figure). In a case where a difference of a reference block template searched within each 4×4 local search range is less than a difference corresponding to a corresponding sorted BV, a BV corresponding to the newly searched reference block template may replace the sorted BV in the candidate list to participate in the sorting of intraTMPCandList, otherwise, the candidate list may not be updated.

In the present embodiment, sizes of the local search range in the horizontal direction and the vertical direction are exactly the same as the first search step, which may avoid overlapping of the local search ranges.

If the sub-sample precision is supported, a third-level search may be performed after the second-level search. The BV used in the third-level search is a BV of the sub-sample. For example, based on the position indicated by the BV of the integer sample selected in the second-level search, a ½ sample search is performed within a sample range of up, bottom, left and right. Based on the BV of the integer sample selected in the second step, a ½ sample search is performed within a sample range of up, bottom, left and right. Four BVs are set, which are obtained by offsetting an x coordinate of the BV of the integer sample by #½ sample and a y coordinate of the BV of the integer sample by +½ sample. In another example, four BVs may be obtained by offsetting both x and y coordinates by +½ samples. That is, 4 or 8 BVs may be set for search in the local search range. In other embodiments, the BV of the sub-sample may be used in the second-level search, or the BV of the sub-sample may be used in the fourth-level search.

A local search range is determined according to a BV, and a position indicated by the BV may be used as a center point of the local search range, or a point neighboring to the center, but is not limited thereto. As shown in FIG. 13B, the position indicated by the BV used in the first-level search is located at a point neighboring to the center of the 4×4 local search range, and the coordinates of the point in the local search range may be recorded as (2, 2). However, the position indicated by the BV used in the first-level search may also be used as a point at the bottom-right corner of the local search range to determine the local search range.

Constructing the candidate list is a process that needs to be performed by both the encoding side and the decoding side, so as to ensure that the candidate list obtained by the encoding side is consistent with the candidate list obtained by the decoding side.

In the present embodiment, the number required by intraTMPCandList is N. After the first-level search, N BVs are recorded (written into the candidate list). During the second-level search, N local search ranges are determined based on the N BVs to continue searching. In another embodiment, more BVs may be recorded after the first-level search (in addition to the N BVs written into the candidate list, other BVs may also be saved), for example, M BVs may be recorded, where M is greater than N. For example, M is equal to 2N. In this way, there may be more opportunities to improve the search and the number of regions suitable for the second-level search that are missed due to the first-level sparse search may be reduced.

In the present embodiment, the maximum number of BVs retained in each local search range may be set, that is, the number threshold of BVs that may be at most filled into intraTMPCandList in each local search range may be set. The number threshold may be determined according to the length N of the candidate list and the size of the local search range. For example, if N is relatively small, each local search range may be set to retain a relatively large amount of BVs to avoid excessive concentration of candidate reference blocks. If N is relatively large, that is, the number of candidate reference blocks is relatively large, each local search range may retain more BVs, so that there is a certain degree of granularity while ensuring the coverage.

The number of BVs retained in each local search range may be determined using one of the following methods.

### Method 1

Each local search range may only retain at most one BV in intraTMPCandList.

### Method 2

Each improvement region may have any number of BVs retained in intraTMPCandList, that is, there is no limitations on the maximum number of BVs that may be retained in each improvement search region. If the number of candidates is large enough, such a setting may be used to improve the precision.

### Method 3

A number threshold K is set, and the number of BVs retained in each local search range in intraTMPCandList need to be less than or equal to K. In each local search range, K BVs with the smallest differences may be determined by sorting, and then these K BVs are attempted to be added to intraTMPCandList.

The encoder and the decoder need to perform the same search to ensure that the lists constructed thereby are the same. Generally, the larger the search range, the more the BVs that may be searched, the greater the possibility, but the higher the complexity. Therefore, a reasonable search range may be a trade-off between performance and complexity.

The intraTMP is an intra block copy technology, which copies a block with the same size as the current block. That is, the larger the current block, the larger the region to be copied, and the smaller the current block, the smaller the region to be copied. A method is to set the search range to be related to a size of the block, for example, set a search range searchRange Width in the horizontal direction to be equal to ratio times width (i.e., searchRangeWidth=ratioxwidth) and set the search range searchRangeHeight in the vertical direction to be equal to ratio times height (i.e., searchRangeHeight=ratioxheight). Herein, ratio is a multiple, such as 4, 5 or 6; width is a width of the current block, and height is a height of the current block. However, the search range cannot exceed the available reconstructed region. Considering that the current codec supports a minimum 4×4 block, taking a 4×4 block as an example, ignoring the limitation of the maximum available region, ratio is set to 5, and searchRangeWidth and searchRangeHeight are both set to 20. This range is very small, and an ideal situation for intraTMP search is to find textures that are repeated with the current block. Therefore, a threshold may be set to ensure that the minimum search range is not too small. For example, the size of the search range may be set in one of the following ways, where the size of the search range is represented by search distances relative to a base point representing the position of the current block.

### Method 1

$$searchRangeWidth = max ( ratio \times width , thrLowerBoundary )$$

$$searchRangeHeight = max ( ratio \times height , thrLowerBoundary )$$

where thrLowerBoundary is the lowest search range, such as 64 or 128.

### Method 2

The following method may also be used.

$$searchRangeWidth = ratio \times max ( width , thrLowerBoundary )$$

$$searchRangeHeight = ratio \times max ( height , thrLowerBoundary )$$

where thrLowerBoundary is 16 or 32.

Here, width and height are respectively the width and the height of the current block, ratio is a set proportional factor in the width direction and height direction; searchRangeWidth and searchRangeHeight are respectively the search distances in the width direction and the height direction, and thrLowerBoundary is the minimum search distance in the width direction and the height direction.

### Method 3

In this Method, a larger ratio is set for the small block. For example, if a width or a height is less than 16, the corresponding ratio is 10, otherwise, the corresponding ratio is 5.

The setting of the search range may not depend on multi-candidate, and the search range may also be set using the above method for a single-candidate intraTMP.

In an embodiment, a high-level control syntax may be set to control the size of the first search step, such as setting a control of sps_intraTmp_search_step_idx of an sps (sequence parameter set) to control the size of the first search step. If sps_intraTmp_search_step_idx is 0, the search step is 3. If sps_intraTmp_search_step_idx is 1, the search step is 4. A large search step may be set for a high-resolution video, and a small search step may be set for a low-resolution video.

In the present embodiment, intraTMPCandList is sorted. From a perspective of statistical laws, the candidate at the front has a great probability of being selected. The variable-length coding may be set for binarization and inverse binarization of intra TMPIndex as follows, or the truncated unary (TU) coding may be used.

| | |
|---|---|
| intraTMPIndex | Binary Symbols |

| | | |
|---|---|---|
| 0 | 1 | |
| 1 | 0 | 1 |
| 2 | 0 | 0 |
| Bin index | 0 | 1 |

If each candidate reference block has similar probability of being selected, the fixed-length coding or the truncated binary coding may be used to implement the binarization of intraTMPCandList. The Bin index in the above table is an index of the binary symbol. If Bin index is 0, it indicates a first binary symbol, and if Bin index is 1, it indicates a second binary symbol.

In the scenario where N is relatively large, the probabilities of the candidates at the front are large, the probabilities of the candidates at the back are small, and the probabilities of the candidates at the back are close, in a case where a value of intraTMPIndex is relatively small, the encoded codeword is short, and in a case where a value of intraTMPIndex is relatively large, the encoded codeword is long. Some candidate reference blocks close to each other in the candidate list may use the same code length. An example is as follows:

| IntraTmpIdx | Binary Symbols | | | | |
|---|---|---|---|---|---|
| 0 | 1 | 1 | | | |
| 1 | 1 | 0 | 0 | | |
| 2 | 1 | 0 | 1 | | |
| 3~6 | 0 | x | x | x | |
| 7~14 | 0 | x | x | x | x |

In this example, N is 15, indexes 3 to 6 use codewords of the same length, and indexes 7 to 14 use codewords of the same length. The x in the above table may be obtained via truncated binary coding.

In the present embodiment, a high-level control syntax may be used to control whether to use the multi-candidate technology. If the multi-candidate technology is not used, the existing technology, that is, the single-candidate method, may be used. An example is to use an SPS (sequence parameter set) flag, such as sps_intra_tmp_multi_cand_enabled_flag. If the value of sps_intra_tmp_multi_cand_enabled_flag is 1, the current sequence uses the multi-candidate intraTMP method, otherwise, the current sequence uses the single-candidate intraTMP method.

The corresponding syntax is as follows:

intra_tmp_flag
If (sps_intra_tmp_multi_cand_enabled_flag && intra_tmp_flag)
{
intra_tmp_index
}

A usage scenario of using the above high-level control syntax is to set sps_intra_tmp_multi_cand_enabled_flag to 1 for the camera acquisition sequence and set sps_intra_tmp_multi_cand_enabled_flag to 0 for the screen content sequence. Of course, PPS (picture parameter set), picture header, slice header and other flags may also be used to achieve picture-level or slice-level control.

The embodiments of the present disclosure may set more candidates for intraTMP to reduce the situation where the optimal matching block found by template matching is not ideal, thereby improving compression performance.

In a case of encoding content captured by the camera, due to an influence of lighting, noise, geometric deformation and the like, even repeated textures are rarely exactly the same, and it is difficult for intraTMP to search for completely matching blocks. Ideally, repeated textures will be found in intraTMP. Repeating textures may also appear in the content captured by the camera, such as patterns on the floor, patterns on textiles and grilles on the wall. For some complex textures, intraTMP may obtain the complex textures by copying, which may improve the compression efficiency. However, if no ideal matching block is found, intraTMP will not work. If better matching blocks may be provided, the encoding performance of intraTMP may be improved and the compression efficiency may be further improved.

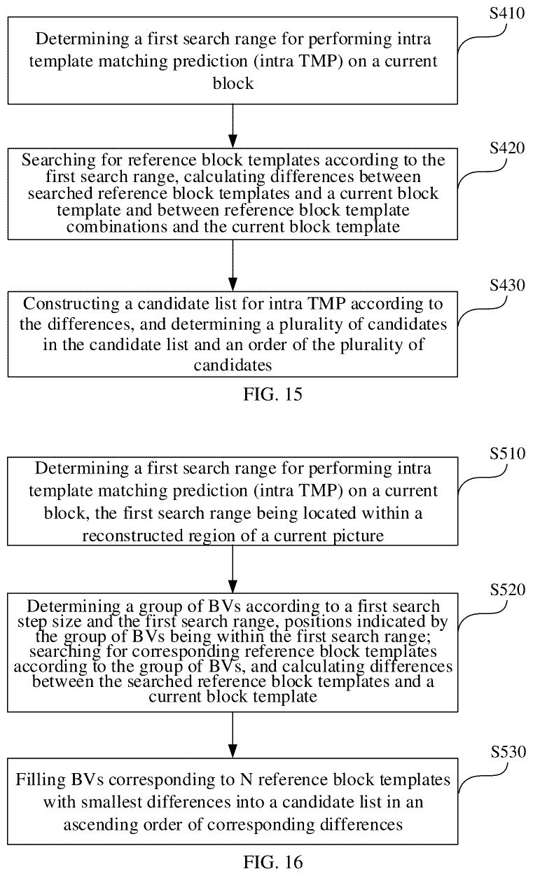

An embodiment of the present disclosure provides a candidate list construction method for intra template matching prediction, and as shown in FIG. 15, the method includes:
S410, determining a first search range for performing intra template matching prediction (intraTMP) on a current block;
S420, searching for reference block templates according to the first search range, calculating differences between searched reference block templates and a current block template and between reference block template combinations and the current block template; where the reference block templates correspond one-to-one to reference blocks, and the reference block template combinations correspond one-to-one to reference block combinations; and
S430, constructing a candidate list for intraTMP according to the differences, and determining a plurality of candidates in the candidate list and an order of the plurality of candidates.

Based on the previous embodiments, reference block template combinations are added as options in the candidate list in the present embodiment, so that there are more options when intra prediction is performed using the intraTMP mode, thereby effectively improving the compression efficiency. In the present embodiments, for the same processing and the same terms as those in the previous embodiments, reference may be made to the description of the previous embodiments. When the same or similar means as those in the previous embodiments are adopted in the present embodiment, the same technical effects as those in the previous embodiments may be achieved.

In an exemplary embodiment of the present disclosure, the searched reference block templates are all located within a reconstructed region of a current picture;
differences between the reference block templates and the current block template are determined according to a sum of absolute difference (SAD), a sum of absolute transformed difference (SATD) or a mean-square error (MSE) between reconstructed values of the reference block templates and reconstructed values of the current block template; and
differences between the reference block template combinations and the current block template are determined according to an SAD, an SATD or an MSE between reconstructed values after fusing a plurality of reference block templates combined and the reconstructed values of the current block template; where the reconstructed values after fusing the plurality of reference block templates is equal to an average or a weighted average of reconstructed values of the plurality of reference block templates.

In an exemplary embodiment of the present disclosure, the candidate list includes a first candidate list of length N₁, and N₁ candidates in the first candidate list includes reference blocks and/or reference block combinations; and
an order of the N₁ candidates is determined according to an ascending order of differences between corresponding reference block templates and the current block, and/or differences between corresponding reference block template combinations and the current block; where the reference blocks correspond to the reference block templates, and the reference block combinations correspond to the reference block template combinations.

In an exemplary embodiment of the present disclosure, the reference blocks are each identified by a block vector (BV) of a reference block; where the BV of the reference block is used to indicate a position of the reference block relative to the current block, and a BV corresponding to a reference block template is a BV of a reference block corresponding to the reference block template.

In an example of the present embodiment, searching for the reference block templates according to the first search range, calculating the differences between the searched reference block templates and the current block template and between the reference block template combinations and the current block template, and constructing the candidate list according to the differences includes:
determining a group of BVs according to a first search step and the first search range, where positions indicated by the group of BVs are within the first search range;
searching for corresponding reference block templates according to the group of BVs, and calculating first differences between the searched reference block templates and the current block template;
combining P reference block templates with smallest differences with other reference block templates, and calculating second differences between the reference block template combinations obtained and the current block template, P being greater than or equal to 1; and
sorting the first differences and the second differences, and filling flags corresponding to reference block templates and/or reference block template combinations corresponding to smallest N differences into the first candidate list;
where flags corresponding to the reference block templates are BVs corresponding to the reference block templates, and flags corresponding to the reference block template combinations are flags of the reference block combinations corresponding to the reference block template combinations.

In an example of the present embodiment, searching for the reference block templates according to the first search range, calculating the differences between the searched reference block templates and the current block template and between the reference block template combinations and the current block template, and constructing the candidate list according to the differences includes:
determining a group of BVs according to a first search step and the first search range, where positions indicated by the group of BVs are within the first search range;
searching for corresponding reference block templates according to the group of BVs, and calculating first differences between the searched reference block templates and the current block template; and
filling BVs corresponding to N₁ reference block templates with smallest first differences into a first candidate list; where the first candidate list includes N₁ reference blocks;
where flags corresponding to the reference block templates are BVs corresponding to the reference block templates.

In this example, searching for the reference block templates according to the first search range, calculating the differences between the searched reference block templates and the current block template and between the reference block template combinations and the current block template, and constructing the candidate list according to the differences further includes:
combining P reference block templates with smallest first differences with other reference block templates, and calculating second differences between the reference block template combinations obtained and the current block template; and
filling flags corresponding to N₂ reference block template combinations with smallest second differences into a second candidate list, where the second candidate list includes N₂ reference block combinations;
where flags corresponding to the reference block template combinations are flags of the reference block combinations corresponding to the reference block template combinations, P is greater than or equal to N₂, and N₂ is greater than or equal to 1 or N₂ is greater than or equal to 2.

In an example of the present embodiment, the reference block combinations each include a first reference block and L−1 second reference blocks, the L−1 second reference blocks are L−1 reference blocks whose BVs are closest to a BV of the first reference block; a distance between two BVs is determined according to a distance between positions indicated by the two BVs, L is a number of reference blocks in the reference block combination, and L is greater than or equal to 2; or
the reference block combinations each include a first reference block and L−1 second reference blocks, and the L−1 second reference blocks are reference blocks obtained by predicting the current block according to a set intra prediction mode, L is greater than or equal to 2;
where the reference block corresponding to the P reference block templates is the first reference block.

In this example, the P reference block templates with the smallest first differences are combined with other reference block templates, and the obtained reference block template combinations are different reference block template combinations. Deduplication processing may be used to ensure that the obtained reference block template combinations are different from each other.

In this example, the reference block combinations are each identified by BVs of a plurality of reference blocks in the combination; or the reference block combinations are each identified by the BV of the first reference block in the combination plus a fusion flag.

In an exemplary embodiment of the present disclosure, the searched reference block templates include a first reference block template and/or a second reference block template;
the first reference block template is a template within a reconstructed region that has a same shape and a same size as the current block template, where the reconstructed region is a reconstructed region of a picture where the current block is located; and
the second reference block template is a template obtained by performing affine transformation on a local region of the reconstructed region and having a same shape and a same size as the current block template, and a reference block corresponding to the second reference block template is a reference block obtained by performing affine transformation on the local region; or the second reference block template is a template within the reconstructed region and having the same shape and the same size as the current block template having performed affine transformation, and a reference block corresponding to the second reference block template is a block within the reconstructed region;
where the affine transformation includes any one or more of flipping, rotation and zoom.

In an exemplary embodiment of the present disclosure, a size of the first search range is determined according to a size of the current block.

In an example of the present embodiment, relative to a base point representing a position of the current block, of the first search range, a first search distance in a width direction and a second search distance in a height direction are determined as follows:
calculating a product of a width of the current block and a first scale factor, and using a larger value between the product and a set minimum search distance in the width direction as the first search distance; calculating a product of a height of the current block and a second scale factor, and using a larger value between the product and a set minimum search distance in the height direction as the second search distance, where the first scale factor and the second scale factor are equal or different; or
determining a larger value between a width of the current block and a set minimum search distance in the width direction, and using a product of the larger value and a first scale factor as the first search distance; determining a larger value between a height of the current block and a set minimum search distance in the height direction, and using a product of the larger value and a second scale factor as the second search distance, where the first scale factor and the second scale factor are equal or different; or
multiplying a width of the current block by a corresponding first scale factor to obtain the first search distance, where there are a plurality of first scale factors, and the larger the first scale factor, the larger the corresponding width of the current block; multiplying a height of the current block by a corresponding second scale factor to obtain the second search distance, where there are a plurality of second scale factors, and the larger the second scale factor, the larger the corresponding height of the current block.

The embodiments of the present disclosure further provide a candidate list construction method for intra template matching prediction, and as shown in FIG. 16, the method includes:
S510, determining a first search range for performing intra template matching prediction (intraTMP) on a current block; where the first search range is located within a reconstructed region of a current picture;
S520, determining a group of BVs according to a first search step and the first search range, where positions indicated by the group of BVs are within the first search range; searching for corresponding reference block templates according to the group of BVs, and calculating differences between the searched reference block templates and a current block template; and
S530, filling BVs corresponding to N reference block templates with smallest differences into a candidate list in an ascending order of corresponding differences, where N is a length of the candidate list, and N is greater than or equal to 2;
where the reference block templates correspond one-to-one to reference blocks; the differences between the reference block templates and the current block template are determined according to an SAD, an SATD or an MSE between reconstructed values of the reference block templates and reconstructed values of the current block template; a BV of a reference block is used to indicate a position of the reference block relative to the current block, and a BV corresponding to a reference block template is a BV of a reference block corresponding to the reference block template.

As analyzed above, the present embodiment may improve the compression efficiency.

In an exemplary embodiment of the present disclosure, the searched reference block templates include a first reference block template and/or a second reference block template
the first reference block template is a template within the reconstructed region that has a same shape and a same size as the current block template, where the reconstructed region is a reconstructed region of a picture where the current block is located; and
the second reference block template is a template obtained by performing affine transformation on a local region of the reconstructed region and having the same shape and the same size as the current block template, and a reference block corresponding to the second reference block template is a reference block obtained by performing affine transformation on the local region; or the second reference block template is a template within the reconstructed region and having the same shape and the same size as the current block template having performed affine transformation, and a reference block corresponding to the second reference block template is a block within the reconstructed region;
where the affine transformation includes any one or more of flipping, rotation and zoom.

By increasing the types of the reference block templates, more possibilities may be provided. In a case where there are a plurality of blocks with affine transform relationships on the picture, a block with the highest matching degree may be found, thereby improving the coding efficiency.

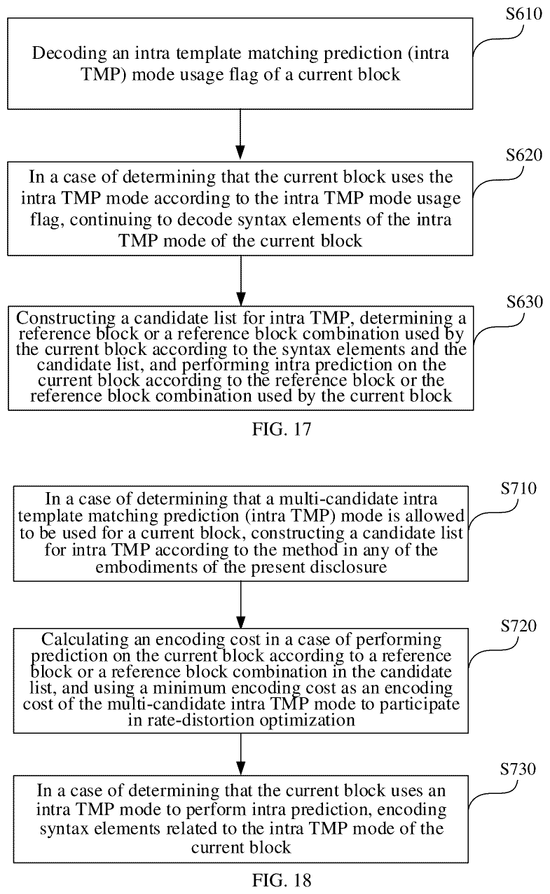

An embodiment of the present disclosure further provides a video decoding method, and as shown in FIG. 17, the method includes:
S610, decoding an intra template matching prediction (intraTMP) mode usage flag of a current block;
S620, in a case of determining that the current block uses the intraTMP mode according to the intraTMP mode usage flag, continuing to decode syntax elements of the intraTMP mode of the current block; and
S630, constructing a candidate list for intraTMP, determining a reference block or a reference block combination used by the current block according to the syntax elements and the candidate list, and performing intra prediction on the current block according to the reference block or the reference block combination used by the current block.

In a case of decoding the current block in the present embodiment, prediction may be performed by a multi-candidate intraTMP mode and in combination with the fusion method, thereby improving the compression efficiency.

In an exemplary embodiment of the present disclosure, the candidate list is constructed according to the candidate list construction method of intraTMP in any of the embodiments of the present disclosure.

In an exemplary embodiment of the present disclosure, template matching is performed using a second reference block template.

After determining that the current block is decoded using the intraTMP mode according to the intraTMP mode usage flag, the method further includes: decoding a syntax element related to a type of the reference block template, where the syntax element related to the type of the reference block template is used to indicate whether using affine transformation is allowed to obtain the reference block template, and/or to indicate the type of the affine transformation used; where the type of the affine transformation includes any one or more of flipping, rotation and zoom.

In an exemplary embodiment of the present disclosure, performing intra prediction on the current block according to the reference block combination used by the current block includes: using reconstructed values after fusing a plurality of reference blocks in the reference block combination as a prediction value of the current block; where the reconstructed values after fusing the plurality of reference blocks is equal to an average or a weighted average of reconstructed values of the plurality of reference blocks.

In an exemplary embodiment of the present disclosure, the candidate list is constructed according to the aforementioned candidate list construction method of only constructing the first candidate list; and
continuing to decode the syntax elements of the intraTMP mode of the current block, and determining the reference block or the reference block combination used by the current block according to the syntax elements and the candidate list, includes:
continuing to decode an intraTMP index, where the intraTMP index is used to indicate a position of the reference block or the reference block combination used by the current block in the candidate list; and
determining the reference block or the reference block combination used by the current block according to the intraTMP index and the first candidate list.

In an exemplary embodiment of the present disclosure, the candidate list is constructed according to the aforementioned candidate list construction method using the reference block as a candidate; and
continuing to decode the syntax elements of the intraTMP mode of the current block, and determining the reference block or the reference block combination used by the current block according to the syntax elements and the candidate list, includes:
continuing to decode an intraTMP fusion flag, where the intraTMP fusion flag is used to indicate whether the current block uses a fusion method in the intraTMP mode;
in a case of determining that the current block uses the fusion method according to the intraTMP fusion flag, skipping decoding an intraTMP index, and determining that a reconstructed value after fusing first Q reference blocks in the candidate list is used to perform prediction on the current block, where Q is a set fusion number, and Q is greater than or equal to 2; and
in a case of determining that the current block does not use the fusion method according to the intraTMP fusion flag, continuing to decode the intraTMP index, and determining the reference block used by the current block according to the intraTMP index and the candidate list; where the intraTMP index is used to indicate a position of the reference block used by the current block in the candidate list.

The candidate list constructed in the present embodiment is a candidate list that only includes reference blocks but does not include a reference block combination. The fusion method in the present embodiment is to directly fuse the first several reference blocks in the combination candidate list. The encoding side constructs the first candidate list without comparing the differences between the reference block combinations, and without specially constructing a second candidate list including the reference block combination.

In an exemplary embodiment of the present disclosure, the candidate list is constructed according to the aforementioned candidate list construction method using the reference block as a candidate; and
continuing to decode the syntax elements of the intraTMP mode of the current block, and determining the reference block or the reference block combination used by the current block according to the syntax elements and the candidate list, includes:
continuing to decode an intraTMP index;
in a case where the intraTMP index is 0, determining that the reference block combination used by the current block is a combination of first Q reference blocks in the candidate list, where Q is a set fusion number, and Q is greater than or equal to 2; and
in a case where the intraTMP index indicates a position other than a first position in the candidate list, determining the reference block used by the current block according to the intraTMP index and the candidate list; where the intraTMP index is used to indicate a position of the reference block used by the current block in the candidate list.

In the above embodiment, in a case where the current block uses the intraTMP mode, whether to use the fusion method in the intraTMP mode may be determined according to the result of rate-distortion optimization.

In an exemplary embodiment of the present disclosure, the candidate list includes a first candidate list or a second candidate list, and the first candidate list or the second candidate list is constructed according to the method of constructing the first candidate list or the second candidate list in the aforementioned method of constructing two candidate lists; and
continuing to decode the syntax elements of the intraTMP mode of the current block, and determining the reference block or the reference block combination used by the current block according to the syntax elements and the candidate list includes:
continuing to decode an intraTMP fusion flag and an intraTMP index;
in a case of determining that the current block does not use a multi-reference block fusion method according to the intraTMP fusion flag, determining a position of the reference block used by the current block in the first candidate list according to the first candidate list and the intraTMP index, where the intraTMP index is used to indicate the position of the reference block used by the current block in the first candidate list; and
in a case of determining that the current block uses the multi-reference block fusion method according to the intraTMP fusion flag, determining a position of the reference block combination used by the current block in the second candidate list according to the second candidate list and the intraTMP index, where the intraTMP index is used to indicate the position of the reference block combination used by the current block in the second candidate list.

In an exemplary embodiment of the present disclosure, the method further includes: decoding an intraTMP multi-candidate flag, and determining whether a multi-candidate intraTMP mode is allowed to be used according to the intraTMP multi-candidate flag, where the intraTMP multi-candidate flag is a sequence level flag, a picture level flag or a slice level flag; and
after determining that the current block uses the intraTMP mode according to the intraTMP mode usage flag, the method further includes:
in a case of determining that the multi-candidate intraTMP mode is allowed to be used according to the intraTMP multi-candidate flag, continuing to decode an intraTMP index of the current block; and
in a case of determining that the multi-candidate intraTMP mode is not allowed to be used according to the intraTMP multi-candidate flag, skipping decoding the intraTMP index of the current block, and performing intra prediction on the current block based on a single-candidate intraTMP mode.

In an exemplary embodiment of the present disclosure, decoding the intraTMP index of the current block includes:
implementing inverse binarization of the intraTMP index by a parsing method corresponding to variable-length coding, fixed-length coding, truncated unary coding, or truncated binary coding; or
parsing a value of a first binary symbol in the intraTMP index, in a case where the value is one of 0 and 1, implement inverse binarization of the intraTMP index by a parsing method corresponding to variable-length coding or truncated unary coding, and in a case where the value is the other of 0 and 1, implement inverse binarization of the intraTMP index by a parsing method corresponding to fixed-length coding or truncated binary coding.

An embodiment of the present disclosure further provides a video encoding method, and as shown in FIG. 18, the method includes:
S710, in a case of determining that a multi-candidate intraTMP mode is allowed to be used for a current block, constructing a candidate list for intraTMP according to the candidate list construction method for intraTMP in any of the embodiments of the present disclosure;
S720, calculating an encoding cost in a case of performing prediction on the current block according to a reference block or a reference block combination in the candidate list, and using a minimum encoding cost as an encoding cost of the multi-candidate intraTMP mode to participate in rate-distortion optimization; and
S730, in a case of determining that the current block uses an intraTMP mode to perform intra prediction, encoding syntax elements related to the intraTMP mode of the current block.

In a case of encoding the current block in the present embodiment, a multi-candidate intraTMP mode may be used and a fusion method may be combined, thereby improving the compression efficiency.

In an exemplary embodiment of the present disclosure, the candidate list is constructed according to the aforementioned candidate list construction method of only constructing the first candidate list; and
encoding the syntax elements related to the intraTMP mode of the current block includes:
encoding an intraTMP mode usage flag of the current block to indicate that the current block uses the intraTMP mode; and
encoding an intraTMP index of the current block to indicate a position of the reference block or reference block combination used by the current block in the candidate list.

In an exemplary embodiment of the present disclosure, the candidate list is constructed according to the aforementioned candidate list construction method using the reference block as a candidate; and
encoding the syntax elements related to the intraTMP mode of the current block includes:
encoding an intraTMP mode usage flag of the current block to indicate that the current block uses the intraTMP mode;
continuing to encode an intraTMP fusion flag to indicate whether the current block uses a fusion method in the intraTMP mode;
in a case where the intraTMP fusion flag indicates that the current block does not use the fusion method, continuing to encode an intraTMP index to indicate a position of the reference block used by the current block in the candidate list; and
in a case where the intraTMP fusion flag indicates that the current block uses the fusion method, skipping encoding the intraTMP index;
where the current block using the fusion method means that a reconstructed value after fusing first Q reference blocks in the candidate list is used to perform intra prediction on the current block, Q is a set fusion number, and Q is greater than or equal to 2.

In an exemplary embodiment of the present disclosure, the candidate list is constructed according to the aforementioned candidate list construction method using the reference block as a candidate; and
encoding the syntax elements related to the intraTMP mode of the current block includes:
encoding an intraTMP mode usage flag of the current block to indicate that the current block uses the intraTMP mode; and
encoding an intraTMP index, where in a case of determining that a fusion method in the intraTMP mode is currently used, the intraTMP index is 0; in a case of determining that the reference block in the candidate list is currently used, the intraTMP index is used to indicate a position of the reference block used by the current block in the candidate list;
where the current block using the fusion method means that a reconstructed value after fusing first Q reference blocks in the candidate list is used to perform intra prediction on the current block, where Q is a set fusion number, and Q is greater than or equal to 2.

In an exemplary embodiment of the present disclosure, the candidate list includes a first candidate list and a second candidate list, and the first candidate list and the second candidate list are constructed according to the aforementioned method for constructing two candidate lists; and
encoding the syntax elements related to the intraTMP mode of the current block includes:
encoding an intraTMP mode usage flag of the current block to indicate that the current block uses the intraTMP mode;
continuing to encode an intraTMP fusion flag and an intraTMP index;
in a case where the current block uses a reference block in the first candidate list, the intraTMP fusion flag indicates that a multi-reference block fusion method is not used, and the intraTMP index indicates a position of the reference block used by the current block in the first candidate list; and
in a case where the current block uses a reference block combination in the second candidate list, the intraTMP fusion flag indicates that the multi-reference block fusion method is used, and the intraTMP index indicates a position of the reference block combination used by the current block in the second candidate list.

In an exemplary embodiment of the present disclosure, the reconstructed block templates have a plurality of types; and
encoding the syntax elements related to the intraTMP mode of the current block further includes: after encoding the intraTMP mode usage flag of the current block, encoding syntax elements related to reference block template types, where the syntax elements related to the reference block template types are used to indicate whether affine transformation is allowed to be used to obtain the reference block template, and/or to indicate a type of the affine transformation used;
where the type of the affine transformation includes any one or more of flipping, rotation and zoom.

In an exemplary embodiment of the present disclosure, encoding the intraTMP index of the current block includes:
implementing binarization of the intraTMP index by variable-length coding, fixed-length coding, truncated unary coding, or truncated binary coding; or
in a case where a value of the intraTMP index is located within a first value range, implementing binarization of the intraTMP index by the variable-length coding or the truncated unary coding; and in a case where a value of the intraTMP index is located within a second value range, implementing binarization of the intraTMP index by the fixed-length coding or the truncated binary coding, where values in the first value range are smaller than values in the second value range.

In an exemplary embodiment of the present disclosure, determining that the multi-candidate intraTMP mode is allowed to be used for the current block includes: in a case where all conditions in which the multi-candidate intraTMP mode is not allowed to be used are not met, determining that the multi-candidate intraTMP mode is allowed to be used for the current block, where the conditions in which the multi-candidate intraTMP mode is not allowed to be used include: an intraTMP multi-candidate flag at a sequence level, a picture level or a slice level indicating that the multi-candidate intraTMP mode is not allowed to be used.

In an exemplary embodiment of the present disclosure, the method further includes: in a case of performing intra prediction encoding on the current block based on a single-candidate intraTMP mode, encoding an intraTMP mode usage flag of the current block to indicate that the current block uses the intraTMP mode; and encoding an intraTMP index of the current block to indicate that the reference block used by the current block is at a first position in the candidate list.

An embodiment of the present disclosure further provides a candidate list construction method for intra template matching prediction and a corresponding video encoding and decoding method.

The present embodiment may increase possible matching blocks via a multi-block fusion method, such as fusion of two or three or more reference blocks. A fusion method is to average or weighted average reconstructed values of a plurality of reference blocks as a prediction value of a current block. That is, sample values at the corresponding positions of each reference block in the above two or three or more reference blocks are averaged or weighted averaged to obtain the fused block, that is, a new block may be constructed by fusion.

In another embodiment, another fusion method is adopted, in which a reference block or a reference block combination is found from the reconstructed picture using a BV, and then prediction is performed using an intra prediction mode (e.g., a planar mode) on the current block, and the obtained prediction block is used as another reference block. The sample values of the two reference blocks are averaged or weighted averaged to obtain the prediction block of the current block.

In the present embodiment, another reference block template and another reference block may be obtained through affine transformation. The affine transformation may be any one or more of rotation, flipping and zoom.

In some embodiments, during searching for a reference block template in a reconstructed region, the reconstructed picture is compared intact with the current block template. During use, the reconstructed value of the reference block in the reconstructed picture is directly used as the prediction value of the current block. This form may be called a basic form, and the reference block template searched is the first reference block template in the above embodiments. In the present embodiment, affine transformation, such as horizontal flipping, vertical flipping, clockwise or counterclockwise rotation of 45 degrees, 90 degrees or 180 degrees, is performed on the reconstructed picture in the local region within the reconstructed region, so as to obtain a template (i.e., the second reference block template) having the same shape and the same size as the current block template via the affine transformation. In this case, the reference block corresponding to the second reference block template is a reference block obtained after performing affine transformation on the local region, and prediction needs to be performed on the current block using the reference block obtained after performing affine transformation.

There is another way to obtain the second reference block template, which is to obtain, by searching, a template in the reconstructed region that has the same shape and the same size as the current block template after affine transformation. In this case, the reference block corresponding to the second reference block template is a block in the reconstructed region.

In an example, flipping is easier to implement than rotation, and only flipping may be used without rotation during use. In another example, rotation may also be used if complexity permits.

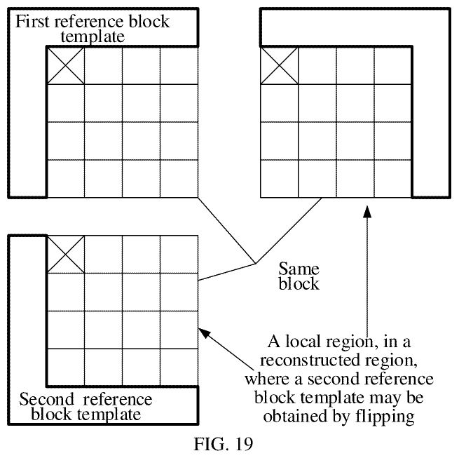

When searching for the second reference block template in the present embodiment, as shown in FIG. 19, the BV used when searching for the first reference block template may be used. The small cells marked with crosses in the figure are positions indicated by BVs used to search for reference blocks in the figure. Based on the positions, a local region, in the reconstructed region, where a second reference block template may be obtained by flipping may be found. In another embodiment, a group of BVs used for searching for the second reference block template is different from a group of BVs used for searching for the first reference block template. In a case of determining the group of BVs used for searching for the second reference block template, it may also be determined based on the search step and the search range. The search step and the search range may be the same as the search step and the search range used to determine a group of BVs used for search for the first reference block template, but there is an offset between the two. In a case of determining the group of BVs used to search for the second reference block template, it is necessary to ensure that the local region in which the second reference block template may be obtained by performing affine transformation is located in the available reconstructed region.

In an example of the present embodiment, the second reference block template may be obtained by zooming, that is, the reconstructed picture in the searched local region or the block corresponding to the searched BV may be zoomed in or zoomed out, so that more reference block templates may be obtained. Some zoom ratios for zooming in or out, such as 1.5, 2 or 4, may be set. In a case of zooming in, some up-sampling algorithms, such as interpolation filtering, may be used, and in a case of zooming out, some down-sampling algorithms may be used to obtain reconstructed values of the zoomed second reference block template and the reconstructed value of the corresponding reference block. In a case of zooming, the position indicated by the BV may be used as the base point, or other positions may be used as the base point for zoom.

The present embodiment provides more possibilities based on the multi-candidate intraTMP mode using reference blocks. The decoder may determine, via relevant syntax elements, whether the current block uses a fusion method, whether a second reference block template is used, etc.

A way is to use a flag for indication. For example, intra TmpFusionFlag may be used to indicate whether fusion is used. The corresponding decoding example is as follows, where the boldfaced words are syntax elements to be parsed.

intraTmpFlag
if (intraTmpFlag){
intraTmpFusionFlag
}

The decoder parses intra TmpFlag. If a value of intraTmpFlag is 1, it continues to parse intra TmpFusionFlag. If a value of intra TmpFusionFlag is 1, intraTMP prediction is performed in a fusion method. Otherwise, intraTMP prediction is performed in other ways, such as a default form.

An exemplary decoding syntax combining the fusion method with a plurality of methods of obtaining second reference block templates by affine transformation may be represented as follows:

```
  intraTmpFlag
  if (intraTmpFlag){
    intraTmpFusionFlag
    if (!intraTmpFusionFlag){
      intraTmpFlipFlag
      if (intraTmpFlipFlag){
        intraTmpFlipIdx
    }else{
      intraTmpZoomFlag
      if (intraTmpZoomFlag){
          intraTmpZoomIdx
      }
    }
  }
}
```

The decoder parses intraTmpFlag. If a value of intraTmpFlag is 1, it continues to parse intraTmpFusionFlag. If a value of intraTmpFusionFlag is 1, intraTMP prediction is performed in a fusion method. Otherwise (the value of intraTmpFusionFlag is 0), the decoder parses intraTmpFlipFlag. If a value of intra TmpFlipFlag is 1, intraTmpFlipIdx is parsed where, a value of intraTmpFlipIdx of 0 may indicate that horizontal flipping is used, and a value of intraTmpFlipIdx of 1 may indicate that vertical flipping is used. Otherwise (the value of intraTmpFlipFlag is 0), intraTmpZoomFlag is parsed. If a value of intraTmpZoomFlag is 1, intraTmpZoomIdx is parsed, where a value of intraTmpZoomIdx of 0 may indicate that magnification is used by 2 times, and a value of intraTmpZoomIdx of 1 may indicate that reduction is used by 2 times.

As described above, more candidates (such as reference blocks or reference block combinations) are used in the candidate list may reduce the situation where the optimal matching block found by template matching is not ideal. More candidates may be understood as candidate BVs, and each BV corresponds to a block. Then the fusion method may be used in combination with the multi-candidate intraTMP mode.

### Method 1

An example is as follows

```
intraTmpFlag
if (intraTmpFlag){
  intraTmpFusionFlag
  if(!intraTmpFusionFlag){
    intraTmpIdx
  }
}
```

The decoder parses intraTmpFlag. If a value of intraTmpFlag is 1, it continues to parse intraTmpFusionFlag. If a value of intra TmpFusionFlag is 1, intraTMP prediction is performed in a fusion method. Otherwise (the value of intraTmpFusionFlag is 0), the decoder parses IntraTmpIdx. The intraTMPCandList is constructed, each candidate in intraTMPCandList may determine a BV, and the BV determined by intraTMPCandList [intraTmpIdx] is used to perform intraTMP prediction. An example of a fusion method is to fuse blocks corresponding to BVs determined by first three candidates in intraTMPCandList. In other words, if the fusion method is not used, the multi-candidate intraTmpIdx mode may be used to select the appropriate BVs. In this example, the multi-candidate mode and the fusion method are separated, and the multi-candidate mode is used only in a basic form (without fusion). Multiple candidates may be understood as candidates provided by a sorted list of possible BVs.

### Method 2

Another example is as follows

```
intraTmpFlag
if (intraTmpFlag){
  intraTmpFusionFlag
  intraTmpIdx
}
```

The decoder parses intraTmpFlag. If a value of intraTmpFlag is 1, it continues to parse intraTmpFusionFlag. If a value of intra TmpFusionFlag is 1, intraTMP prediction is performed in a fusion method. The decoder parses intra TmpIdx. The difference from the previous example is that intraTmpIdx is parsed regardless of the value of intraTmpFusionFlag.

The intraTMPCandList is constructed. If a value of intraTmpFusionFlag is 0, each candidate in intraTMPCandList may determine a BV, and the BV determined by intraTMPCandList [intraTmpIdx] is used to perform intraTMP prediction. If a value of intraTmpFusionFlag is 1, each candidate in intraTMPCandList may determine a group of BVs, and the group of BVs determined by intraTMPCandList [intraTmpIdx] is used to perform intraTMP fusion prediction.

In addition to determining a group of BVs, each candidate in intraTMPCandList may also determine a weight of each BV, and some default weights may also be set. That is, in this example, multiple forms may also be superimposed to use multiple candidates. The multiple candidates may be understood as candidates provided by a sorted list of possible candidates in the current form. The multiple candidates here are sorted, which is different from the multiple candidates set according to fixed rules. For example, in the above example, the value of intraTmpFlipIdx of 0 indicates horizontal flipping, and the value of intra TmpFlipIdx of 1 indicates vertical flipping. The sorting may be performed based on the cost on the template.

The above example still separates multiple forms. For example, a flag is used to distinguish between different ways of using reference blocks as candidates and using reference block combinations as candidates, and separate candidate lists are constructed for the reference blocks and the reference block combinations. The candidates in one candidate list are reference blocks, and the candidates in the other candidate list are reference block combinations.

### Method 3

The fusion method and the multi-candidate mode may be combined in another way, and multiple forms of candidates, such as both reference blocks and reference block combinations, may be supported in a candidate list. In a case where the fusion method is combined with the multi-candidate mode, the reference block template to be searched may be the first reference block template or the second reference block template, or both the first reference block template and the second reference block template.

An example of decoding is as follows:

intraTmpFlag
if (intraTmpFlag){
intraTmpIdx
}

In this case, instead of using various flags to distinguish different methods, a candidate list is constructed to support multiple forms of candidates. For example, a certain candidate in the candidate list is a reference block, another candidate is a fused reference block combination, the reference block templates corresponding to these reference blocks may be the first reference block templates and/or the second reference block templates, and these second reference block templates may be obtained by flipping or the like. From the perspective of data structure, each candidate in the candidate list may contain information about the form of the current candidate, for example, whether it is a reference block, whether it is a reference block fusion, and whether it is obtained by flipping. The information may be determined according to positions of candidates in the candidate list, which is the same list constructed at the encoding side and the decoding side. Candidates in a form of reference blocks may be represented by the BVs of the reference blocks, and candidates in a form of reference block combinations may be represented by a plurality of BVs or a BV of a reference template plus a fusion flag, which will not be repeated here. The candidate in the form of reference block combination contains the information of the BV of the current candidate. There may be one valid BV or a plurality of valid BVs, and the plurality of valid BVs may be used to support the fusion form.

During constructing the candidate list, the sorting may still be performed according to the differences (also referred to as costs) between potential candidates and the current block template. For the fusion form, that is, the reference block template combination, a possible method is to fuse several reference block templates in the combination. For the flipping form, the template may be flipped accordingly, or the corresponding template may be found in the flipped reconstructed picture. For the zoom form, the template may be zoomed accordingly, or the corresponding template may be found in the zoomed reconstructed picture. Such ways may allow for great flexibility, as the content of the video varies, and one form may be useful for some blocks, while another form may be useful for other blocks. Candidates of various forms are put into a candidate list and sorted by some algorithms, for example, candidates are sorted in ascending order according to the costs on the templates. Then, regardless of the forms, candidates with small costs on the templates will be placed at the front, and candidates with large costs on the templates will be placed at the back. Candidates ranked at the front are usually assigned shorter codeword for encoding, while candidates ranked at the back are usually assigned longer codeword for encoding. Therefore, the length of the codeword is not directly determined by the form, but depends on the size of the cost of the candidate on the template.

### Method 4

This method adopts some compromise solutions. An example is that some forms are distinguished by flags and some forms are put into a candidate list. The list may be constructed by means of templates or the like so that the sorting of the candidate list is as close as possible to the actual likely order of these candidates. Of course, it is indeed statistically close. However, since original information of the current block cannot be used during sorting, and only information such as templates may be used, it is impossible to be completely accurate for a single individual. Therefore, a manual control may be used to distinguish certain obviously dominant forms with flags and put certain other forms in the candidate list. An example is as follows:

```
intra TmpFlag
if (intraTmpFlag){
  intraTmpFusionFlag
  if(!intraTmpFusionFlag) {
    intraTmpIdx
  }
}
```

The decoder parses intraTmpFlag. If a value of intraTmpFlag is 1, it continues to parse intraTmpFusionFlag. If a value of intra TmpFusionFlag is 1, intraTMP prediction is performed in a fusion method. Otherwise (the value of intraTmpFusionFlag is 0), the decoder parses intraTmpIdx.

It may be seen that the parsing syntax is the same as that in method 1, but the difference is that the candidate list intraTMPCandList in method 1 only supports the basic form, while the candidate list in this example may support a plurality of forms, such as basic form, flipping and zoom.

Another example is as follows

intraTmpFlag
if (intraTmpFlag){
intraTmpIdx
}

The flag is still not used in the syntax. If intra TmpIdx is 0, the fusion form is selected. If intra TmpIdx is greater than 0, a candidate in intraTmpCandList [intraTmpIdx-1] is selected. The intraTmpCandList supports multiple forms except fusion. In this case, intraTmpCandList [0], intraTmpCandList [1], and intraTmpCandList [2] may be selected for fusion.

### Binarization Method of Intra TmpIdx

Since intraTmpCandList is sorted, statistically speaking, the candidates at the front have a great probability of being selected. Variable-length coding may set for the binarization and inverse binarization of intraTmpIdx as follows, or truncated unary coding may be used.

| | |
|---|---|
| htra TmpIdx | Binary Symbols |

| | | |
|---|---|---|
| 0 | 1 | |
| 1 | 0 | 1 |
| 2 | 0 | 0 |
| Bin index | 0 | 1 |

If the probabilities are similar, fixed-length coding or truncated binary may be used.

If N is relatively large, the probabilities of the candidates at the front are large, and the probabilities of the candidates at the back are small, and the probabilities of the candidates at the back are close. Therefore, the codeword at the front may be short and the codeword at the back may be long, and some candidates at the back may use the same code length. An example is as follows:

| IntraTmpIdx | Binary Symbols | | | | |
|---|---|---|---|---|---|
| 0 | 1 | 1 | | | |
| 1 | 1 | 0 | 0 | | |
| 2 | 1 | 0 | 1 | | |
| 3~6 | 0 | x | x | x | |
| 7~14 | 0 | x | x | x | x |

In this example, Nis 15, indexes 3 to 6 use codewords of the same length, and indexes 7 to 14 use codewords of the same length. The x in the above table may be obtained using truncated binary code.

As mentioned in the second method in Method 4 above, in addition to relying on sorting, some manual control may also be added. For example, a certain candidate is forced to be placed first. Naturally, it is also possible to force a certain candidate to be placed in a certain position, or group the candidates, or manually set a special code length for a certain index. For example, the fusion form may be forcibly placed at the last position, but assigned a short codeword.

In the present embodiment, a plurality of forms of candidates and a plurality of forms of reference block templates are set for intraTMP, and several methods for combining the plurality of forms and the plurality of candidates are proposed. More possibilities increase with more forms. The combination of the plurality of forms and the plurality of candidates not only enriches the possible sets of candidates, but also makes an effective use of the candidate list. For example, if the basic form (e.g., taking the reference block as the candidate and using the first reference block template) does not have suitable candidates or does not have enough suitable candidates, while other forms may provide suitable candidates, and more suitable candidates may replace unsuitable candidates, so as to improve the quality of the candidates in the entire candidate list, thereby improving the compression efficiency.

An embodiment of the present disclosure further provides a bitstream, and the bitstream is generated based on the video encoding method described in any of the embodiments of the present disclosure.

An embodiment of the present disclosure further provides a candidate list construction device for intra template matching prediction, and as shown in FIG. 14, the candidate list construction device includes a processor 71 and a memory 73 having stored a computer program thereon. The processor 71 may implement, when executing the computer program, the candidate list construction method for intra template matching prediction as described in any of the embodiments of the present disclosure.

An embodiment of the present disclosure further provides a video decoding device, as shown in FIG. 14, including a processor and a memory having stored a computer program thereon. The processor may implement, when executing the computer program, the video decoding method as described in any of the embodiments of the present disclosure.

An embodiment of the present disclosure further provides a video encoding device, as shown in FIG. 14, including a processor and a memory having stored a computer program thereon. The processor may implement, when executing the computer program, the video encoding method as described in any of the embodiments of the present disclosure.

The processor in the above embodiments of the present disclosure may be a general-purpose processor, including a central processing unit (CPU), a network processor (NP), a microprocessor, and the like. Alternatively, the processor may be one of other conventional processors. Alternatively, the processor may be a digital signal processor (DSP), an application specific integrated circuit (ASIC), a field programmable gate array (FPGA), discrete logic or other programmable logic devices, discrete gate or transistor logic devices, discrete hardware components, or other equivalent integrated or discrete logic circuits, or a combination of the above devices. That is, the processor in the above embodiments may be any processing device or device combination that implements various methods, steps and logic block diagrams disclosed in the embodiments of the present disclosure. If the embodiments of the present disclosure are partially implemented in software, instructions for the software may be stored in a suitable non-transitory computer-readable storage medium, and the instructions may be executed in hardware using one or more processors to implement the methods in the embodiments of the present disclosure. The term “processor,” as used herein, may refer to the above structure or any other structure suitable for implementation of the techniques described herein.

An embodiment of the present disclosure further provides a video encoding and decoding system, which includes the video encoding device described in any of the embodiments of the present disclosure and the video decoding device described in any of the embodiments of the present disclosure.

An embodiment of the present disclosure further provides a non-transitory computer-readable storage medium, where the non-transitory computer-readable storage medium has stored a computer program thereon. When the computer program is executed by a processor, the computer program may implement the method described in any of the embodiments of the present disclosure.

An embodiment of the present disclosure further provides a computer program product, including a computer program. The computer program, when executed by a processor, is capable of implementing the method described in any of the embodiments of the present disclosure.

In one or more of the above exemplary embodiments, the described functionality may be implemented in hardware, software, firmware, or any combination thereof. If implemented in software, the functionality may be stored as one or more instructions or codes on a computer-readable medium or transmitted via a computer-readable medium, and executed by a hardware-based processing unit. The computer-readable medium may include a computer-readable storage medium corresponding to a tangible medium such as a data storage medium, or a communication medium that facilitates the transfer of computer programs from one location to any medium at another location, for example, based on communication protocols. In this way, the computer-readable medium typically corresponds to a non-temporary tangible computer-readable storage medium or a communication medium such as signals or carrier waves. The data storage medium may be any available medium that may be accessed by one or more computers or one or more processors to retrieve instructions, codes, and/or data structures used to implement the techniques described in the present disclosure. The computer program products may include the computer-readable medium.

By way of example and not limitation, such computer-readable storage media may include a random-access memory (RAM), a read-only memory (ROM), an electrically erasable programmable read-only memory (EEPROM), a compact disc read-only memory (CD-ROM) or other optical disk storage, magnetic disk storage or other magnetic storage devices, a flash memory, or any other medium that may be used to store desired program codes in a form of instructions or data structures and that may be accessed by a computer. Furthermore, any connection may be referred to as a computer-readable medium. For example, if instructions are transmitted from a website, server, or other remote source using a coaxial cable, fiber optic cable, twisted pair, digital subscriber line (DSL), or wireless technologies such as infrared, radio and microwave, the coaxial cable, fiber optic cable, twisted pair, DSL, or wireless technologies such as infrared, radio and microwave are included in the definition of medium. It should be understood, however, that the computer-readable storage medium and data storage medium do not include connections, carrier waves, signals, or other transient media, but are instead directed to non-transient tangible storage media. As used herein, magnetic disk and discs include compact discs (CDs), laser discs, optical discs, digital versatile discs (DVDs), floppy disks, or Blu-ray discs, etc. The magnetic disks usually reproduce data in a magnetic way, while the discs reproduce data in an optical way with lasers. Combinations of the above should also be included within the scope of computer-readable media.

In some aspects, the functionality described herein may be provided within dedicated hardware and/or software modules configured for encoding and decoding, or incorporated in a combined codec. Furthermore, the techniques could be fully implemented in one or more circuits or logic elements.

The technical solutions in the embodiments of the present disclosure may be widely implemented in a variety of devices or apparatuses, including a wireless mobile phone, an integrated circuit (IC), or a group of ICs (e.g., a chipset). Various components, modules, or units are described in the embodiments of the present disclosure to emphasize functional aspects of devices configured to perform the described techniques, but do not necessarily require realization by different hardware units. Rather, as described above, the various units may be combined in a codec-side hardware unit or provided by a collection of interoperating hardware units (including one or more processors as described above) in conjunction with appropriate software and/or firmware.

In a first clause, a candidate list construction method for intra template matching prediction is provided, which includes:
determining a first search range for performing intra template matching prediction (intraTMP) on a current block;
searching for reference block templates according to the first search range, calculating differences between searched reference block templates and a current block template and between reference block template combinations and the current block template; where the reference block templates correspond one-to-one to reference blocks, and the reference block template combinations correspond one-to-one to reference block combinations; and
constructing a candidate list for intraTMP according to the differences, and determining a plurality of candidates in the candidate list and an order of the plurality of candidates.

In a second clause, according to the first clause, where
the searched reference block templates are all located within a reconstructed region of a current picture;
differences between the reference block templates and the current block template are determined according to a sum of absolute difference (SAD), a sum of absolute transformed difference (SATD) or a mean-square error (MSE) between reconstructed values of the reference block templates and reconstructed values of the current block template; and
differences between the reference block template combinations and the current block template are determined according to an SAD, an SATD or an MSE between reconstructed values after fusing a plurality of reference block templates combined and the reconstructed values of the current block template; where reconstructed values after fusing the plurality of reference block templates is equal to an average or a weighted average of reconstructed values of the plurality of reference block templates.

In a third clause, according to the first clause, where
the candidate list includes a first candidate list of length N1, and N1 candidates in the first candidate list include reference blocks and/or reference block combinations; and
an order of the N1 candidates is determined according to an ascending order of differences between corresponding reference block templates and the current block, and/or differences between corresponding reference block template combinations and the current block; where the reference blocks correspond to the reference block templates, and the reference block combinations correspond to the reference block template combinations.

In a fourth clause, according to the first clause, where
the reference blocks are each identified by a block vector (BV) of a reference block; where the BV of the reference block is used to indicate a position of the reference block relative to the current block, and a BV corresponding to a reference block template is a BV of a reference block corresponding to the reference block template.

In a fifth clause, according to the fourth clause, where
searching for the reference block templates according to the first search range, calculating the differences between the searched reference block templates and the current block template and between the reference block template combinations and the current block template, and constructing the candidate list according to the differences, includes:
determining a group of BVs according to a first search step and the first search range, where positions indicated by the group of BVs are within the first search range;
searching for corresponding reference block templates according to the group of BVs, and calculating first differences between the searched reference block templates and the current block template;
combining P reference block templates with smallest differences with other reference block templates, and calculating second differences between the reference block template combinations obtained and the current block template, P being greater than or equal to 1; and
sorting the first differences and the second differences, and filling flags corresponding to reference block templates and/or reference block template combinations corresponding to smallest N differences into the first candidate list;
where flags corresponding to the reference block templates are BVs corresponding to the reference block templates, and flags corresponding to the reference block template combinations are flags of the reference block combinations corresponding to the reference block template combinations.

In a sixth clause, according to the fourth clause, where
searching for the reference block templates according to the first search range, calculating the differences between the searched reference block templates and the current block template and between the reference block template combinations and the current block template, and constructing the candidate list according to the differences, includes:
determining a group of BVs according to a first search step and the first search range, where positions indicated by the group of BVs are within the first search range;
searching for corresponding reference block templates according to the group of BVs, and calculating first differences between the searched reference block templates and the current block template; and
filling BVs corresponding to N1 reference block templates with smallest first differences into a first candidate list; the first candidate list including N1 reference blocks;
where flags corresponding to the reference block templates are BVs corresponding to the reference block templates.

In a seventh clause, according to the sixth clause, where
searching for the reference block templates according to the first search range, calculating the differences between the searched reference block templates and the current block template and between the reference block template combinations and the current block template, and constructing the candidate list according to the differences, further includes:
combining P reference block templates with smallest first differences with other reference block templates, and calculating second differences between the reference block template combinations obtained and the current block template; and
filling flags corresponding to N2 reference block template combinations with smallest second differences into a second candidate list, the second candidate list including N2 reference block combinations;
where flags corresponding to the reference block template combinations are flags of the reference block combinations corresponding to the reference block template combinations, P is greater than or equal to N2, and N2 is greater than or equal to 1 or N2 is greater than or equal to 2.

In an eighth clause, according to the fifth clause or seventh clause, where
the reference block combinations each includes a first reference block and L−1 second reference blocks, the L−1 second reference blocks are L−1 reference blocks, of which BVs are closest to a BV of the first reference block; a distance between two BVs is determined according to a distance between positions indicated by the two BVs, L is a number of reference blocks in the reference block combination, and L is greater than or equal to 2; or
the reference block combinations each include a first reference block and L−1 second reference blocks, and the L−1 second reference blocks are reference blocks obtained by predicting the current block according to a set intra prediction mode, L is greater than or equal to 2;
where reference blocks corresponding to the P reference block templates are the first reference block.

In a ninth clause, according to the eighth clause, where
the reference block combinations are each identified by BVs of a plurality of reference blocks in the combination; or the reference block combinations are each identified by the BV of the first reference block in the combination plus a fusion flag.

In a tenth clause, according to the first clause, where
the searched reference block templates include a first reference block template and/or a second reference block template;
the first reference block template is a template within a reconstructed region that has a same shape and a same size as the current block template, where the reconstructed region is a reconstructed region of a picture where the current block is located; and
the second reference block template is a template obtained by performing affine transformation on a local region of the reconstructed region and having a same shape and a same size as the current block template, and a reference block corresponding to the second reference block template is a reference block obtained by performing the affine transformation on the local region; or the second reference block template is a template within the reconstructed region and having a same shape and a same size as the current block template having performed affine transformation, and a reference block corresponding to the second reference block template is a block within the reconstructed region;
where the affine transformation includes any one or more of flipping, rotation and zoom.

In an eleventh clause, according to the first clause, where
a size of the first search range is determined according to a size of the current block.

In a twelfth clause, according to the eleventh clause, where
relative to a base point representing a position of the current block, of the first search range, a first search distance in a width direction and a second search distance in a height direction are determined as follows:
calculating a product of a width of the current block and a first scale factor, and using a larger value between the product and a set minimum search distance in the width direction as the first search distance; calculating a product of a height of the current block and a second scale factor, and using a larger value between the product and a set minimum search distance in the height direction as the second search distance, where the first scale factor and the second scale factor are equal or different; or
determining a larger value between a width of the current block and a set minimum search distance in the width direction, and using a product of the larger value and a first scale factor as the first search distance; determining a larger value between a height of the current block and a set minimum search distance in the height direction, and using a product of the larger value and a second scale factor as the second search distance, where the first scale factor and the second scale factor are equal or different; or
multiplying a width of the current block by a corresponding first scale factor to obtain the first search distance, where there are a plurality of first scale factors, and the larger the first scale factor, the larger the corresponding width of the current block; multiplying a height of the current block by a corresponding second scale factor to obtain the second search distance, where there are a plurality of second scale factors, and the larger the second scale factor, the larger the corresponding height of the current block.

In a thirteenth clause, a candidate list construction method for intra template matching prediction is provided, which includes:
determining a first search range for performing intra template matching prediction (intraTMP) on a current block; the first search range being located within a reconstructed region of a current picture;
determining a group of block vectors (BVs) according to a first search step and the first search range, positions indicated by the group of BVs being within the first search range; searching for corresponding reference block templates according to the group of BVs, and calculating differences between the searched reference block templates and a current block template; and
filling BVs corresponding to N reference block templates with smallest differences into a candidate list in an ascending order of corresponding differences, N being a length of the candidate list, and N being greater than or equal to 2;
where the reference block templates correspond one-to-one to reference blocks; the differences between the reference block templates and the current block template are determined according to a sum of absolute difference (SAD), a sum of absolute transformed difference (SATD) or a mean-square error (MSE) between reconstructed values of the reference block templates and reconstructed values of the current block template; a BV of a reference block is used to indicate a position of the reference block relative to the current block, and a BV corresponding to a reference block template is a BV of a reference block corresponding to the reference block template.

In a fourteenth clause, according to the thirteenth clause, where
the searched reference block templates include a first reference block template and/or a second reference block template;
the first reference block template is a template within the reconstructed region that has a same shape and a same size as the current block template, where the reconstructed region is a reconstructed region of a picture where the current block is located; and
the second reference block template is a template obtained by performing affine transformation on a local region of the reconstructed region and having a same shape and a same size as the current block template, and a reference block corresponding to the second reference block template is a reference block obtained by performing the affine transformation on the local region; or the second reference block template is a template within the reconstructed region and having a same shape and a same size as the current block template having performed affine transformation, and a reference block corresponding to the second reference block template is a block within the reconstructed region;
where the affine transformation includes any one or more of flipping, rotation and zoom.

In a fifteenth clause, a video decoding method is provided, which includes:
decoding an intra template matching prediction (intraTMP) mode usage flag of a current block;
in a case of determining that the current block uses the intraTMP mode according to the intraTMP mode usage flag, continuing to decode syntax elements of the intraTMP mode of the current block; and
constructing a candidate list for intraTMP, determining a reference block or a reference block combination used by the current block according to the syntax elements and the candidate list, and performing intra prediction on the current block according to the reference block or the reference block combination used by the current block.

In a sixteenth clause, according to the fifteenth clause, where
the candidate list is constructed according to the candidate list construction method for intraTMP as claimed in any one of claims 1 to 14.

In a seventeenth clause, according to the fifteenth clause, where
performing intra prediction on the current block according to the reference block combination used by the current block, includes: using reconstructed values after fusing a plurality of reference blocks in the reference block combination as a prediction value of the current block; where the reconstructed values after fusing the plurality of reference blocks is equal to an average or a weighted average of reconstructed values of the plurality of reference blocks.

In a eighteenth clause, according to the seventeenth clause, where
the candidate list is the first candidate list constructed according to the method as claimed in claim 5; and
continuing to decode the syntax elements of the intraTMP mode of the current block, and determining the reference block or the reference block combination used by the current block according to the syntax elements and the candidate list, includes:
continuing to decode an intraTMP index, where the intraTMP index is used to indicate a position of the reference block or the reference block combination used by the current block in the candidate list; and
determining the reference block or the reference block combination used by the current block according to the intraTMP index and the first candidate list.

In a nineteenth clause, according to the fifteenth clause, where
the candidate list is the candidate list constructed according to the method as claimed in claim 13 or 14; and
continuing to decode the syntax elements of the intraTMP mode of the current block, and determining the reference block or the reference block combination used by the current block according to the syntax elements and the candidate list, includes:
continuing to decode an intraTMP fusion flag, where the intraTMP fusion flag is used to indicate whether the current block uses a fusion method in the intraTMP mode;
in a case of determining that the current block uses the fusion method according to the intraTMP fusion flag, skipping decoding an intraTMP index, and determining that a reconstructed value after fusing first Q reference blocks in the candidate list is used to perform prediction on the current block, where Q is a set fusion number, and Q is greater than or equal to 2; and
in a case of determining that the current block does not use the fusion method according to the intraTMP fusion flag, continuing to decode the intraTMP index, and determining the reference block used by the current block according to the intraTMP index and the candidate list; where the intraTMP index is used to indicate a position of the reference block used by the current block in the candidate list.

In a twentieth clause, according to the fifteenth clause, where
the candidate list is the candidate list constructed according to the method as claimed in claim 13 or 14; and
continuing to decode the syntax elements of the intraTMP mode of the current block, and determining the reference block or the reference block combination used by the current block according to the syntax elements and the candidate list, includes:
continuing to decode an intraTMP index;
in a case where the intraTMP index is 0, determining that the reference block combination used by the current block is a combination of first Q reference blocks in the candidate list, where Q is a set fusion number, and Q is greater than or equal to 2; and
in a case where the intraTMP index indicates a position other than a first position in the candidate list, determining the reference block used by the current block according to the intraTMP index and the candidate list; where the intraTMP index is used to indicate a position of the reference block used by the current block in the candidate list.

In a twenty-first clause, according to the fifteenth clause, where
the candidate list includes a first candidate list or a second candidate list, where the first candidate list or the second candidate list is constructed according to the method as claimed in claim 7; and
continuing to decode the syntax elements of the intraTMP mode of the current block, and determining the reference block or the reference block combination used by the current block according to the syntax elements and the candidate list, includes:
continuing to decode an intraTMP fusion flag and an intraTMP index;
in a case of determining that the current block does not use a multi-reference block fusion method according to the intraTMP fusion flag, determining a position of the reference block used by the current block in the first candidate list according to the first candidate list and the intraTMP index, where the intraTMP index is used to indicate the position of the reference block used by the current block in the first candidate list; and
in a case of determining that the current block uses the multi-reference block fusion method according to the intraTMP fusion flag, determining a position of the reference block combination used by the current block in the second candidate list according to the second candidate list and the intraTMP index, where the intraTMP index is used to indicate the position of the reference block combination used by the current block in the second candidate list.

In a twenty-second clause, according to the eighteenth clause, the method further includes:
decoding an intraTMP multi-candidate flag, and determining whether a multi-candidate intraTMP mode is allowed to be used according to the intraTMP multi-candidate flag, where the intraTMP multi-candidate flag is a sequence level flag, a picture level flag or a slice level flag; and
after determining that the current block uses the intraTMP mode according to the intraTMP mode usage flag, the method further includes:
in a case of determining that the multi-candidate intraTMP mode is allowed to be used according to the intraTMP multi-candidate flag, continuing to decode an intraTMP index of the current block; and
in a case of determining that the multi-candidate intraTMP mode is not allowed to be used according to the intraTMP multi-candidate flag, skipping decoding the intraTMP index of the current block, and performing intra prediction on the current block based on a single-candidate intraTMP mode.

In a twenty-third clause, according to any one of the eighteenth clause to the twenty-second clause, where
decoding the intraTMP index of the current block, includes:
implementing inverse binarization of the intraTMP index by a parsing method corresponding to variable-length coding, fixed-length coding, truncated unary coding or truncated binary coding; or
parsing a value of a first binary symbol in the intraTMP index, in a case where the value is one of 0 and 1, implement inverse binarization of the intraTMP index by a parsing method corresponding to variable-length coding or truncated unary coding, and in a case where the value is the other of 0 and 1, implement inverse binarization of the intraTMP index by a parsing method corresponding to fixed-length coding or truncated binary coding.

In a twenty-fourth clause, a video encoding method is provided, which includes:
in a case of determining that a multi-candidate intra template matching prediction (intraTMP) mode is allowed to be used for a current block, constructing a candidate list for intraTMP according to the method as claimed in claims 1 to 14;
calculating an encoding cost in a case of performing prediction on the current block according to a reference block or a reference block combination in the candidate list, and using a minimum encoding cost as an encoding cost of the multi-candidate intraTMP mode to participate in rate-distortion optimization; and
in a case of determining that the current block uses an intraTMP mode to perform intra prediction, encoding syntax elements related to the intraTMP mode of the current block.

In a twenty-fifth clause, according to the twenty-fourth clause, where
the candidate list is the first candidate list constructed according to the method as claimed in claim 5; and
encoding the syntax elements related to the intraTMP mode of the current block, includes:
encoding an intraTMP mode usage flag of the current block to indicate that the current block uses the intraTMP mode; and
encoding an intraTMP index of the current block to indicate a position of the reference block or reference block combination used by the current block in the candidate list.

In a twenty-sixth clause, according to the twenty-fourth clause, where
the candidate list is the candidate list constructed according to the method as claimed in claim 13 or 14; and
encoding the syntax elements related to the intraTMP mode of the current block, includes:
encoding an intraTMP mode usage flag of the current block to indicate that the current block uses the intraTMP mode;
continuing to encode an intraTMP fusion flag to indicate whether the current block uses a fusion method in the intraTMP mode;
in a case where the intraTMP fusion flag indicates that the current block does not use the fusion method, continuing to encode an intraTMP index to indicate a position of the reference block used by the current block in the candidate list; and
in a case where the intraTMP fusion flag indicates that the current block uses the fusion method, skipping encoding the intraTMP index;
where the current block using the fusion method means that a reconstructed value after fusing first Q reference blocks in the candidate list is used to perform intra prediction on the current block, Q is a set fusion number, and Q is greater than or equal to 2.

In a twenty-seventh clause, according to the twenty-fourth clause, where
the candidate list is the candidate list constructed according to the method as claimed in claim 13 or 14; and
encoding the syntax elements related to the intraTMP mode of the current block, includes:
encoding an intraTMP mode usage flag of the current block to indicate that the current block uses the intraTMP mode; and
encoding an intraTMP index, where in a case of determining that a fusion method in the intraTMP mode is currently used, the intraTMP index is 0; in a case of determining that the reference block in the candidate list is currently used, the intraTMP index is used to indicate a position of the reference block used by the current block in the candidate list;
where the current block using the fusion method means that a reconstructed value after fusing first Q reference blocks in the candidate list is used to perform intra prediction on the current block, Q is a set fusion number, and Q is greater than or equal to 2.

In a twenty-eighth clause, according to the twenty-fourth clause, where
the candidate list includes a first candidate list and a second candidate list, where the first candidate list and the second candidate list are each constructed according to the method as claimed in claim 7; and
encoding the syntax elements related to the intraTMP mode of the current block, includes:
encoding an intraTMP mode usage flag of the current block to indicate that the current block uses the intraTMP mode;
continuing to encode an intraTMP fusion flag and an intraTMP index;
in a case where the current block uses a reference block in the first candidate list, the intraTMP fusion flag indicates that a multi-reference block fusion method is not used, and the intraTMP index indicates a position of the reference block used by the current block in the first candidate list; and
in a case where the current block uses a reference block combination in the second candidate list, the intraTMP fusion flag indicates that the multi-reference block fusion method is used, and the intraTMP index indicates a position of the reference block combination used by the current block in the second candidate list.

In a twenty-ninth clause, according to any one of the twenty-fifth clause to twenty-eighth clause, where
the candidate list is constructed according to the method as claimed in claim 10 or 14; and
encoding the syntax elements related to the intraTMP mode of the current block, further includes: after encoding the intraTMP mode usage flag of the current block, encoding syntax elements related to reference block template types, where the syntax elements related to the reference block template types are used to indicate whether affine transformation is allowed to be used to obtain the reference block template, and/or to indicate a type of the affine transformation used;
where the type of the affine transformation includes any one or more of flipping, rotation and zoom.

In a thirtieth clause, according to any one of the twenty-fifth clause to twenty-eighth clause, where
encoding the intraTMP index of the current block, includes:
implementing binarization of the intraTMP index by variable-length coding, fixed-length coding, truncated unary coding, or truncated binary coding; or
in a case where a value of the intraTMP index is located within a first value range, implementing binarization of the intraTMP index by the variable-length coding or the truncated unary coding; and in a case where a value of the intraTMP index is located within a second value range, implementing binarization of the intraTMP index by the fixed-length coding or the truncated binary coding, where values in the first value range are smaller than values in the second value range.

In a thirty-first clause, according to the twenty-fourth clause, where
determining that the multi-candidate intraTMP mode is allowed to be used for the current block, includes: in a case where all conditions in which the multi-candidate intraTMP mode is not allowed to be used are not met, determining that the multi-candidate intraTMP mode is allowed to be used for the current block, where the conditions in which the multi-candidate intraTMP mode is not allowed to be used include: an intraTMP multi-candidate flag at a sequence level, a picture level or a slice level indicating that the multi-candidate intraTMP mode is not allowed to be used.

In a thirty-second clause, according to the twenty-fourth clause, the method further includes:
in a case of performing intra prediction encoding on the current block based on a single-candidate intraTMP mode, encoding an intraTMP mode usage flag of the current block to indicate that the current block uses the intraTMP mode; and encoding an intraTMP index of the current block to indicate that the reference block used by the current block is at a first position in the candidate list.

What is claimed is:

1. A video decoding method, comprising:
decoding an intra template matching prediction mode usage flag of a current block;
in a case of determining that the current block uses the intra template matching prediction mode according to the intra template matching prediction mode usage flag, decoding syntax elements of the intra template matching prediction mode of the current block; and
constructing a candidate list for intra template matching prediction, determining a reference block or a reference block combination used by the current block according to the syntax elements and the candidate list, and determining an intra prediction value of the current block according to the reference block or the reference block combination used by the current block.

2. The video decoding method according to claim 1, wherein constructing the candidate list for intra template matching prediction comprises:
determining a first search range for performing intra template matching prediction on a current block;
determining, according to a first search step and the first search range, differences between reference block templates corresponding to one or more block vectors (BVs) and a current block template, wherein positions indicated by the one or more BVs are within the first search range;
determining the candidate list according to the differences between the reference block templates corresponding to the one or more BVs and the current block template.

3. The video decoding method according to claim 1, wherein constructing the candidate list for intra template matching prediction comprises:
determining a first search range for performing intra template matching prediction on a current block;
determining, according to a first search step and the first search range, differences between reference block templates corresponding to one or more block vectors (BVs) and a current block template, wherein positions indicated by the one or more BVs are within the first search range;
determining M second search ranges according to BVs corresponding to M reference block templates with the smallest differences, and determining differences between reference block templates corresponding to M groups of BVs and the current block template, according to a second search step and the M second search ranges, wherein the second search step is smaller than the first search step; and
determining the candidate list according to the differences between the reference block templates corresponding to the M groups of BVs and the current block template.

4. The video decoding method according to claim 2, wherein the candidate list comprises N BVs corresponding to N reference block templates with smallest differences, and differences corresponding to the N BVs are in an ascending order.

5. The video decoding method according to claim 2, wherein the differences between the reference block templates and the current block template are determined according to differences between reconstructed values of the reference block templates and reconstructed values of the current block template.

6. The video decoding method according to claim 1, wherein constructing the candidate list for intra template matching prediction comprises:
determining a first search range for performing intra template matching prediction on a current block;
searching for reference block templates according to the first search range, calculating differences between searched reference block templates and a current block template and between reference block template combinations and the current block template;
determining the candidate list according to the differences between searched reference block templates and a current block template and between reference block template combinations and the current block template.

7. The video decoding method according to claim 6, wherein
differences between the reference block templates and the current block template are determined according to differences between reconstructed values of the reference block templates and reconstructed values of the current block template; and
differences between the reference block template combinations and the current block template are determined according to differences between reconstructed values after fusing a plurality of reference block templates combined and the reconstructed values of the current block template.

8. The video decoding method according to claim 6, wherein the candidate list comprises N₁ BVs corresponding to N₁ reference block templates and/or reference block template combinations with smallest differences, and differences corresponding to the N₁ BVs are in an ascending order.

9. The video decoding method according to claim 2, wherein
a size of the first search range is determined according to a size of the current block.

10. The method according to claim 8, wherein
relative to a base point representing a position of the current block, of the first search range, a first search distance in a width direction and a second search distance in a height direction are determined as follows:
calculating a product of a width of the current block and a first scale factor, and using a larger value between the product and a set minimum search distance in the width direction as the first search distance; calculating a product of a height of the current block and a second scale factor, and using a larger value between the product and a set minimum search distance in the height direction as the second search distance, wherein the first scale factor and the second scale factor are equal or different.

11. The video decoding method according to claim 1, wherein determining the intra prediction value of the current block according to the reference block combination used by the current block comprises:
determining the intra prediction value of the current block according to an average or a weighted average of reconstructed values of the plurality of reference blocks in the reference block combination.

12. The video decoding method according to claim 1, wherein decoding the syntax elements of the intra template matching prediction mode of the current block, and determining the reference block or the reference block combination used by the current block according to the syntax elements and the candidate list comprises:
decoding an intra template matching prediction fusion flag, wherein the intra template matching prediction fusion flag is used to indicate whether the current block uses a fusion method in the intra template matching prediction mode;
in a case of determining that the current block uses the fusion method according to the intra template matching prediction fusion flag, skipping decoding an intra template matching prediction index, and determining the reference block combination used by the current block according to the candidate list; and
in a case of determining that the current block does not use the fusion method according to the intra template matching prediction fusion flag, decoding the intra template matching prediction index, and determining the reference block used by the current block according to the intra template matching prediction index and the candidate list.

13. The video decoding method according to claim 11, wherein decoding the intra template matching prediction index comprises:
parsing a value of a first binary symbol in the intra template matching prediction index, in a case where the value is one of 0 and 1, using variable-length coding or truncated unary coding for binarization of binary symbols other than the first binary symbol in the intra template matching prediction index; and
in a case where the value is the other of 0 and 1, using fixed-length coding or truncated binary coding for binarization of binary symbols other than the first binary symbol in the intra template matching prediction index.

14. A video encoding method, comprising:
in a case of determining that a multi-candidate intra template matching prediction mode is allowed to be used for a current block, constructing a candidate list for intra template matching prediction;
calculating an encoding cost in a case of performing prediction on the current block according to a reference block or a reference block combination in the candidate list, and using a minimum encoding cost as an encoding cost of the multi-candidate intra template matching prediction mode to participate in rate-distortion optimization; and
in a case of determining that the current block uses an intra template matching prediction mode to perform intra prediction, encoding syntax elements related to the intra template matching prediction mode of the current block.

15. The video encoding method according to claim 14, wherein constructing the candidate list for intra template matching prediction comprises:
determining a first search range for performing intra template matching prediction on a current block;
determining, according to a first search step and the first search range, differences between reference block templates corresponding to one or more block vectors (BVs) and a current block template, wherein positions indicated by the one or more BVs are within the first search range;
determining the candidate list according to the differences between the reference block templates corresponding to the one or more BVs and the current block template.

16. The video encoding method according to claim 14, wherein constructing the candidate list for intra template matching prediction comprises:
determining a first search range for performing intra template matching prediction on a current block;
determining, according to a first search step and the first search range, differences between reference block templates corresponding to one or more block vectors (BVs) and a current block template, wherein positions indicated by the one or more BVs are within the first search range;
determining M second search ranges according to BVs corresponding to M reference block templates with the smallest differences, and determining differences between reference block templates corresponding to M groups of BVs and the current block template, according to a second search step and the M second search ranges, wherein the second search step is smaller than the first search step; and
determining the candidate list according to the differences between the reference block templates corresponding to the M groups of BVs and the current block template.

17. The video encoding method according to claim 15, wherein the candidate list comprises N BVs corresponding to N reference block templates with smallest differences, and differences corresponding to the N BVs are in an ascending order.

18. The video encoding method according to claim 14, further comprising:
determining the intra prediction value of the current block according to an average or a weighted average of reconstructed values of the plurality of reference blocks in the reference block combination used for the current block in the candidate list.

19. The method according to claim 14, wherein
encoding the syntax elements related to the intra template matching prediction mode of the current block, comprises:
encoding an intra template matching prediction mode usage flag of the current block to indicate that the current block uses the intraTMP mode;
continuing to encode an intra template matching prediction fusion flag to indicate whether the current block uses a fusion method in the intraTMP mode;
in a case where the intra template matching prediction fusion flag indicates that the current block does not use the fusion method, continuing to encode an intra template matching prediction index to indicate a position of the reference block used by the current block in the candidate list; and
in a case where the intra template matching prediction fusion flag indicates that the current block uses the fusion method, skipping encoding the intra template matching prediction index.

20. A non-transitory computer-readable storage medium, wherein the computer-readable storage medium has stored a computer program and a bitstream, wherein when the computer program executed by a processor, the following method is implemented, to generate the bitstream:
in a case of determining that a multi-candidate intra template matching prediction mode is allowed to be used for a current block, constructing a candidate list for intra template matching prediction;
calculating an encoding cost in a case of performing prediction on the current block according to a reference block or a reference block combination in the candidate list, and using a minimum encoding cost as an encoding cost of the multi-candidate intra template matching prediction mode to participate in rate-distortion optimization; and
in a case of determining that the current block uses an intra template matching prediction mode to perform intra prediction, encoding syntax elements related to the intra template matching prediction mode of the current block.
